(19) United States
(12) Patent Application Publication
(10) Pub. No.: US 2012/0317069 A1
(43) Pub. Date: Dec. 13, 2012

(54) THROUGHPUT SUSTAINING SUPPORT SYSTEM, DEVICE, METHOD, AND PROGRAM

(75) Inventor: Mitsuhiro Oono, Minato-ku (JP)

(73) Assignee: NEC CORPORATION, Minato-ku, Tokyo (JP)

(21) Appl. No.: 13/580,516

(22) PCT Filed: Jan. 21, 2011
(86) PCT No.: PCT/JP2011/000310

§ 371 Date: Aug. 22, 2012

(30) Foreign Application Priority Data
Feb. 23, 2010 (JP) 2010-037850

(51) Int. Cl. G06N 5/02

(52) U.S. Cl. 706/47

(57) ABSTRACT

A throughput sustaining support system (device) according to the present invention has: a throughput sustaining decision unit which decides whether or not throughput can be sustained without exceeding a throughput expected value in a server system based on correspondence data between a throughput value of the server system and a surplus amount of a system resource measured using the expected throughput value which is the throughput value expected upon the number of requests in advance for the server system and pattern data which indicates a pattern of a processing request matching an operating situation of the server system; and a decision result output unit which outputs a decision result as to whether or not the throughput can be sustained without exceeding the expected throughput value decided by the throughput sustaining decision unit.

### TECHNICAL FIELD

The present invention relates to a throughput sustaining support system, a throughput sustaining support device, a throughput sustaining support method, and a throughput sustaining support program which support that throughput in a server system is sustained.

### BACKGROUND ART

Online systems on Internet and intra-company systems generally are server systems which connect a plurality of servers through a network. Particularly, there are many server systems which process a request from a client and return the result to the client, using the application which runs on the servers. In addition, the server system is not necessarily configured using a plurality of servers, and is configured using only one server in some cases.

The server system can be categorized into the application and system resources for running the application. There are various types of applications such as an online business application and a batch job application, and each application is realized by a plurality of programs designed and implemented uniquely for the application.

The system resources for running the application are, more specifically, servers which can have CPU (Central Processing Unit) capacities (the number of CPU cores or CPU frequency), memory capacities, disk capacities, and network capacities (network bandwidths or the number of network adapters). In addition, the each of the servers is not limited to a physical server (a physical information processing device such as a personal computer), and is a virtual server which runs on an interpreter on the physical server in some cases.

Generally, with a server system, to stably run an application, a system administrator monitors performance information of the application, analyzes a bottleneck of the performance and additionally allocates pooled preliminary system resources to the application for which the bottleneck is found.

System administrators give weight to throughput in particular to analyze the bottleneck of performance of the server system. The throughput is the number of transactions (a logical unit of work performed from a request to a response) by the server system within a given time.

The system administrators can analyze that the capacities of system resources are abnormal or run out when actual throughput is smaller than expected throughput in the expected number of requests from the expected number of clients. Further, it is possible to improve throughput by adding and allocating pooled preliminary system resources.

As a technique related to improvement of throughput, a technique of reducing a processing time for allocating preliminary system resources is proposed. For example, Patent Literature 1 discloses a method of grouping preliminary system resources depending on whether or not there is an OS (Operating system) or an application program as a method of reducing a processing time for allocating preliminary system resources. Further, for example, Patent Literature 2 discloses a method of changing a standby state of preliminary system resources based on a product of penalties due to delay of a setting operation time and allocation processing.

According to the method disclosed in Patent Literature 1, a system administrator groups a disk image of a server which installs in advance predetermined software (OS and application programs) depending on whether or not there is a software configuration. Further, when a provisioning request takes place, the proposed device searches for a disk image of the server in order from a group including a close server employing the software configuration of an application which is a bottleneck, so that the system administrator can reduce a processing time for allocating preliminary system resources.

Further, according to the method disclosed in Patent Literature 2, the proposed device functions as a node in an intermediate state in process of allocation processing of system resources, uses a directed graph which uses a setting operation of the allocation processing as an edge and calculates the product of penalties due to delay of the setting operation time and the allocation processing. Furthermore, the proposed device changes the standby state of a pooled surplus disk image of the server such that cost calculated based on the product of the penalties, so that the system administrator can reduce the processing time for allocating surplus system resources.

The related techniques disclosed in Patent Literature 1 and Patent Literature 2 group system resources and change the standby state of the system resources just in case throughput decreases due to an event that processing requests concentrate. Further, by so doing, the allocation processing time is reduced, and a decrease in throughput is prevented.

Furthermore, as a related technique, for example, Patent Literature 3 discloses a resource information management system which computes an average value of a first index indicating a resource state of a first entity and a second index indicating a resource state of a second entity per entity as a reference value for evaluating a resource state of an entity. Still further, for example, Patent Literature 4 discloses a shared system resource management server which decides whether or not a dynamic trigger exceeding a threshold occurs and, when deciding that the trigger occurs, allocates system resources required for an operation.

### CITATION LIST

### Patent Literature

PLT 1: Japanese Patent Application Laid-Open (JP-A) No. 2007-114983
PLT 2: JP-A No. 2007-133654
PLT 3: JP-A No. 2005-4450
PLT 4: JP-A No. 2006-259793

### SUMMARY OF INVENTION

### Technical Problem

An example of a general server system will be described with reference to the drawings. FIG. 13 is a block diagram that illustrates a specific configuration example of a computer network including the server system (business system 300 with this example). With the example illustrated in FIG. 13, a computer network includes a business system 300, a resource pool 400 and a management server 200 which are connected through a network 500.

The business system 300 is a server system which purpose and usage are already defined, and is the server system which returns a specific processing result to a client using a specific application program. However, it is uncertain that the business system 300 can efficiently process an event burst or an event such as software failure or an event such as hardware failure.

As illustrated in FIG. 13, the business system 300 consists, for example, a web server 301, a web AP server (web application server) 302, a DB server (database server) 303 and a storage 304. The web server 301 is a server which functions as an interface with users. Further, the web AP server 302 is an application server which processes an application program. Furthermore, the DB server 303 is a database server which refers to, searches for and updates data stored in the storage 304 in response to a request of the web AP server 302. Still further, the storage 304 is a storage device which stores data of an application program.

In the business system 300, when the web server 301 receives an access (processing request) from a client, the web AP server 302 performs processing matching the request using the application program. Further, upon execution of the processing using the application program, the web AP server 302 refers to, searches for and updates data stored in the storage 304 through the DB server 303, and returns a processing result to the client through the web server 301.

The business system 300 performs the series of processes in response to one processing request from the client, and finishes the processes in response to the processing request when returning the result. In addition, with this example, the business system 300 is an example of a server system of a simple website.

In addition, the web server 301, the web AP server 302, the DB server 303 and the storage 304 included in the business system 300 may run on the same physical server, run on a plurality of physical servers which cooperate with each other through a network or may run a plurality of virtual servers which run in a physical server. That is, a target server system is by no unit limited to the business system illustrated in FIG. 13.

The resource pool 400 is pooled preliminary system resources to which no application is allocated. The system resources are servers which can consists of CPUs, memories, storages and networks in arbitrary combination. Meanwhile, the system resource has at least one CPU, one memory and one network.

Meanwhile, the each of the servers which is the preliminary system resource is not only a physical server but also a virtual server which runs on an interpreter on a physical server. Further, the CPU is not only a physical CPU but also a virtual CPU which runs on the interpreter on the physical CPU. Furthermore, the memory is not only a physical memory but also a virtual memory which runs on the interpreter on the physical memory. Still further, the storage is not only a physical storage but also a virtual storage which runs on the interpreter on the physical storage. Moreover, the network is not only a physical network but also a virtual network which runs on the interpreter on the physical network.

The management server 200 has a provisioning event generation unit 201, a resource pool search unit 202 and a provisioning event processing unit 203. The provisioning event generation unit 201 generates a provisioning event for allocating additional system resources by the measurement result of performance information of the business system 300. The provisioning event refers to an event indicates how many system resources are added to which application. The resource pool search unit 202 stores allocation information of the application and the system resource, and changes the allocation information of the application and the system resource by the provisioning event from the provisioning event generation unit 201. The provisioning event processing unit 203 executes processes of allocating the application and the system resources by the allocation information of the application and the system resources changed by the resource pool search unit 202.

With an example of a computer network including the server system illustrated in FIG. 13, the management server 200 automatically performs processes of monitoring the business system 300, and adding a preliminary server in a resource pool when a running state of the business system 300 is in the predetermined condition (for example, throughput is 30 [req/sec] or less).

However, with the example of the computer network including the server system illustrated in FIG. 13, when throughput of an application of the business system 300 decreases, a provisioning request for adding preliminary system resources is generated, the preliminary system resources required for the application are secured, the OS and the application program are installed, unique parameters are set per application program, the preliminary system resources are added, and then throughput of the application of the business system 300 improves. That is, processing of allocating preliminary system resources is processing which requires time, and therefore such a server system has difficulty in sustaining expected throughput.

Hence, it may be possible to prepare for the preliminary system resources which are all set in advance and use a method of additionally allocating the preliminary system resources (a method employing a redundant configuration). Further, in addition to a method of preparing for the same server system as a running server system, it may be possible to adopt a method of acquiring backup data of the running server system and uploading the backup data upon allocation processing as preliminary system resources which are all set.

According to the above method employing the redundant configuration, what redundant configuration can sustain expected throughput is not clear, and therefore excessive preliminary system resources are prepared to sustain expected throughput. Further, when, for example, the method employing the redundant configuration is applied to a data center which is an assembly of a plurality of business systems and is used, system resources which one business system can use are limited, and therefore it is difficult in some cases to prepare for system resources required for the redundant configuration. A system administrator of the data center needs to learn minimum required system resources for each business system.

Further, the related technique disclosed in Patent Literature 1 and Patent Literature 2 cannot reduce an allocation processing time and sustain expected throughput when an event such as software failure or hardware failure takes place.

For example, according to the method disclosed in Patent Literature 1, the added system resources are returned to the preliminary pool as a disk image with the required application program installed. Hence, the system resources in the preliminary pool concentrate on a disk image of a business system on which processing requests concentrate, and therefore, when failure takes place in the business system on which processing requests do not concentrate, the method disclosed in Patent Literature 1 rather requires a longer processing time compared to a server system which does not group system resources in advance.

A case will be assumed as an example where a business system A requires an application 11 and an application 12, a business system B requires an application 21 and an application 22 and there is one disk image without an installed application. When processing requests concentrate on the business system A, the application 11 and the application 12 are installed in the disk image and system resources are added according to the method disclosed in Patent Literature 1. Further, when concentration of processing requests on the business system A is canceled, the disk image with the installed application 11 and application 12 is returned as is to the preliminary pool according to the method disclosed in Patent Literature 1. That is, when processing requests concentrate more on the business system A than the business system B, system resources in the preliminary pool concentrate on the disk image of the business system A. If software failure or hardware failure does not take place, many system resources are additionally allocated to the business system A on which processing requests concentrate, so that it is possible to reduce the allocation processing time according to the method disclosed in Patent Literature 1.

However, software failure and hardware failure take place irrespectively of the degree of importance of business. Although, according to the method disclosed in Patent Literature 1, additional allocation processing for the business system B is started when software failure or hardware failure takes place in the business system B, the application 11 and the application 12 are uninstalled and the application 21 and the application 22 are installed to use the disk image of the business system A for the disk image of the business system B, and therefore a longer processing time is rather required.

Hence, according to the technique disclosed in Patent Literature 1, when, for example, an event that a system becomes abnormal such as software failure or hardware failure takes place, an allocation processing time cannot be reduced depending on a running situation of the system, and expected throughput cannot be necessarily sustained.

Further, according to, for example, the method disclosed in Patent Literature 2, allocation of system resources in the preliminary pool is determined according to the degree of importance of business. However, the degree of importance of business involves various factors such as a business season and a business hour, a configuration and a running state of a server which provides business, the number of people working on business and other business influenced by the business, and therefore is difficult to set. Further, the system resources in the preliminary pool concentrate on part of application programs having a higher degree of importance, and therefore, when failure takes place in an application having a lower degree of importance, a longer processing time is rather required compared to a server system which allocates resources without using the degree of importance.

A case will be assumed as an example where there are two business systems (the business system A and the business system B). According to the method disclosed in Patent Literature 2, when the degree of importance of the business system A is set higher than the degree of importance of the business system B, the system resources in the preliminary pool concentrate on the business system A. If software failure or hardware failure does not take place, many system resources are additionally allocated to the business system A of a higher degree of importance, so that it is possible to reduce the allocation processing time according to the method disclosed in Patent Literature 2. However, software failure and hardware failure take place irrespectively of the degree of importance of business. Although, according to the method disclosed in Patent Literature 2, additional allocation processing for the business system B is started when failure takes place in the business system B, system resources of the business system A are used for system resources of the business system B and allocation processing is performed, and therefore the extra allocation processing time is rather required.

Thus, according to the method disclosed in Patent Literature 2, it is necessary to set the degree of importance of business taking into account all of various factors including the allocation processing time, and therefore it is difficult to set the degree of importance of business. Hence, according to the technique disclosed in Patent Literature 2, all system administrators decide the reference for allocation processing, and therefore allocation processing for system resources is not necessarily optimal, and expected throughput cannot be necessarily sustained.

Further, allocation of resources can be changed based on a predetermined reference using the related techniques disclosed in Patent Literature 3 and Patent Literature 4. However, a change in an operating situation of the system when, for example, an event that the system becomes abnormal such as software failure or hardware failure is not taken into account at all, and expected throughput cannot be necessarily sustained.

In light of the above problem, and an object of the present invention is to provide a throughput sustaining support system, a throughput sustaining support device, a throughput sustaining support method, and a throughput sustaining support program which can support that throughput is stably sustained taking various operating situations of a system into account.

### Solution to Problem

A throughput sustaining support system according to the present invention has: a throughput sustaining decision unit which decides whether or not throughput can be sustained without exceeding a throughput expected value in a server system based on correspondence data between a throughput value of the server system and a surplus amount of a system resource measured using the expected throughput value which is the throughput value expected upon the number of requests in advance for the server system and pattern data which indicates a pattern of a processing request matching an operating situation of the server system; and a decision result output unit which outputs a decision result as to whether or not the throughput can be sustained without exceeding the expected throughput value decided by the throughput sustaining decision unit.

A throughput sustaining support device according to the present invention has: a throughput sustaining decision unit which decides whether or not throughput can be sustained without exceeding a throughput expected value in a server system based on correspondence data between a throughput value of the server system and a surplus amount of a system resource measured using the expected throughput value which is the throughput value expected upon the number of requests in advance for the server system and pattern data which indicates a pattern of a processing request matching an operating situation of the server system; and a decision result output unit which outputs a decision result as to whether or not the throughput can be sustained without exceeding the expected throughput value decided by the throughput sustaining decision unit.

A throughput sustaining support method according to the present invention includes: deciding whether or not throughput can be sustained without exceeding a throughput expected value in a server system based on correspondence data between a throughput value of the server system and a surplus amount of a system resource measured using the expected throughput value which is the throughput value expected upon the number of requests in advance for the server system and pattern data which indicates a pattern of a processing request matching an operating situation of the server system; and outputting a decision result as to whether or not the throughput can be sustained without exceeding the expected throughput value.

A throughput sustaining support program according to the present invention causing a computer to execute: processing of deciding whether or not throughput can be sustained without exceeding a throughput expected value in a server system based on correspondence data between a throughput value of the server system and a surplus amount of a system resource measured using the expected throughput value which is the throughput value expected upon the number of requests in advance for the server system and pattern data which indicates a pattern of a processing request matching an operating situation of the server system; and processing of outputting a decision result as to whether or not the throughput can be sustained without exceeding the expected throughput value.

### Advantageous Effects of Invention

According to the present invention, it is possible to support that throughput is stably sustained taking various operating situations of a system into account.

### BRIEF DESCRIPTION OF DRAWINGS

FIG. 1 is a block diagram that illustrates an example of a configuration of a throughput sustaining support system according to the present invention.

FIG. 2 is an explanatory view that illustrates an example of simulation pattern data.

FIG. 3 is a functional block diagram that illustrates a function configuration example of the throughput sustaining support system.

FIG. 4 is a flowchart that illustrates a processing example of generating and outputting a throughput sustaining reference.

FIG. 5 is an explanatory view that illustrates a relationship between a system resource surplus amount, throughput and a throughput sustainability.

FIG. 6 is an explanatory view that illustrates a relationship between the system resource surplus amount, the throughput, the throughput sustainability and a throughput sustaining density.

FIG. 7 is a flowchart that illustrates an example of processing of evaluating whether or not a throughput expected value can be sustained.

FIG. 8 is an explanatory view that illustrates a specific example of the system resource surplus amount, the throughput, the throughput sustainability and the throughput sustaining density.

FIG. 9 is a flowchart that illustrates an example of resource amount estimation processing of estimating a required system resource amount.

FIG. 10 is a flowchart that illustrates an example of throughput value estimation processing of estimating the expected throughput value.

FIG. 11 is a block diagram that illustrates another configuration example of the throughput sustaining support system.

FIG. 12 is a functional block diagram that illustrates a minimum function configuration example of the throughput sustaining support system (device).

FIG. 13 is a block diagram that illustrates a specific configuration example of a computer network including a server system.

### DESCRIPTION OF EMBODIMENTS

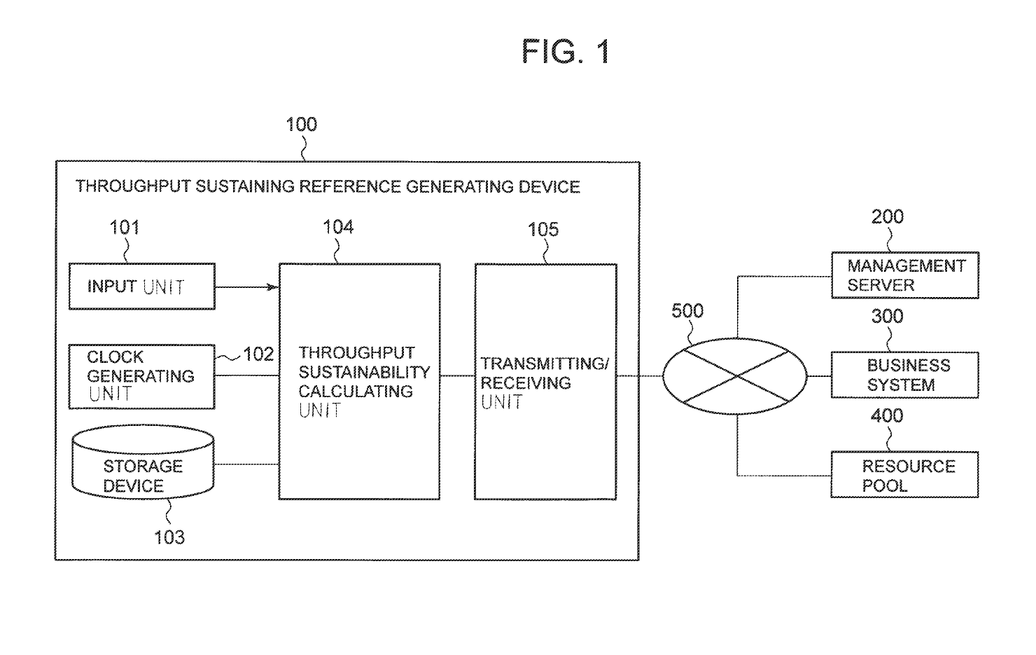

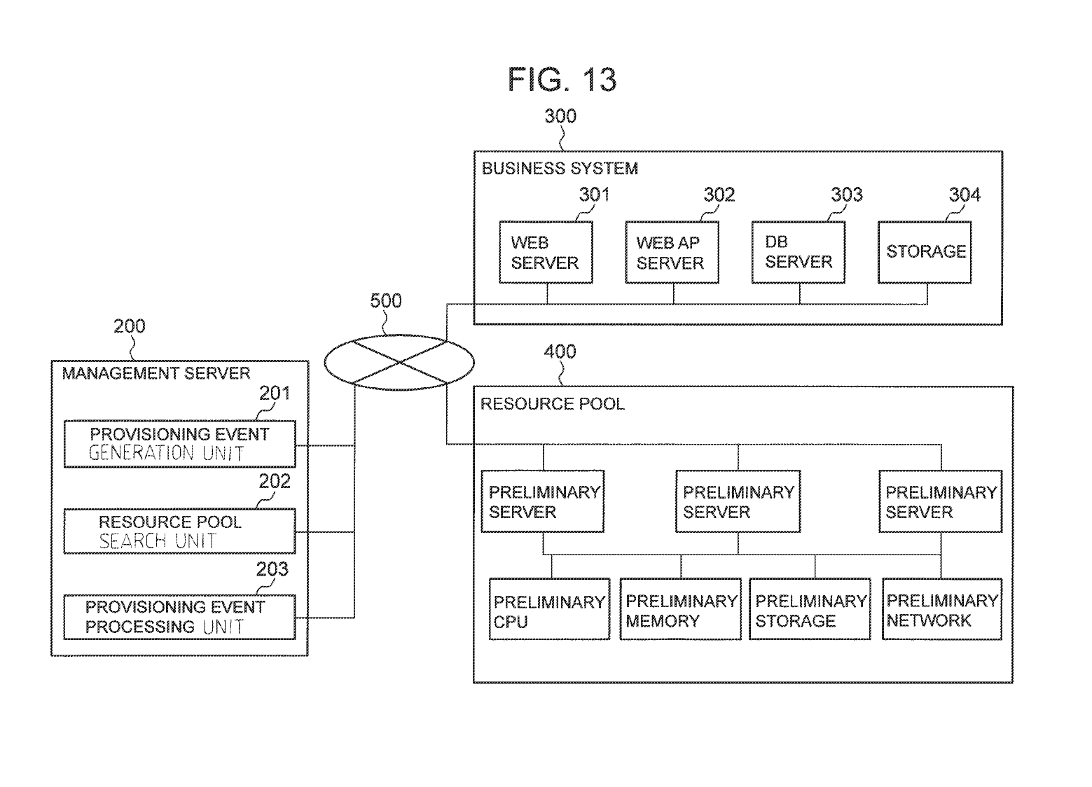

An embodiment of the present invention will be described below with reference to the drawings. FIG. 1 is a block diagram that illustrates an example of a configuration of a throughput sustaining support system according to the present invention. With the present embodiment, as illustrated in FIG. 1, the throughput sustaining support system has a business system 300, a resource pool 400, a management server 200 and a throughput sustaining reference generating device 100. Hence, with the present embodiment, the throughput sustaining support system has the throughput sustaining reference generating device 100 in addition to a configuration of a computer network including the server system illustrated in FIG. 13.

In addition, functions and configurations of the management server 200, the business system 300 and the resource pool 400 are the same as the configurations and the functions of a management server 200, a business system 300 and a resource pool 400 illustrated in FIG. 13. Further, as illustrated in FIG. 1, in the throughput sustaining support system, the throughput sustaining reference generating device 100, the management server 200, the business system 300 and the resource pool 400 are connected through a network 500 such as a LAN to communicate.

The throughput sustaining support system according to the present invention calculates and outputs a required reference value or a system resource amount to stably sustain throughput. More specifically, to stably run, for example, a business application in the business system 300, a throughput value (hereinafter, also referred to as “expected throughput value” or “throughput expected value”) which is a predetermined reference needs to be sustained. Hence, with the present embodiment, the throughput sustaining support system generates a throughput sustaining reference which serves as a reference for analyzing whether or not the expected throughput value is sustained. Further, by allocating resources based on the throughput sustaining reference generated by the throughput sustaining support system, it is possible to sustain throughput expected by the business system 300 and stably run the application on the business system 300.

The throughput sustaining reference generating device 100 is more specifically realized by an information processing device such as a personal computer which operates according to a program. The throughput sustaining reference generating device 100 is operated by, for example, a service provider who provides throughput sustaining support service of supporting that throughput is sustained, to users who use the business system 300. As illustrated in FIG. 1, the throughput sustaining reference generating device 100 has an input unit 101, a throughput sustainability calculating unit 104, a transmitting/receiving unit 105, a clock generating unit 102 and a storage device 103.

The input unit 101 is more specifically realized by an input device such as a keyboard or a mouse of the information processing device. The input unit 101 is, for example, unit which receives an input of data for generating the throughput sustaining reference according to an operation of, for example, a system administrator. More specifically, the input unit 101 is unit which receives an input of throughput expected by the business system 300 and data for simulating the business system 300.

The data for performing simulation includes pattern data of simulation such as a pattern which uniformly produces processing requests matching the number of clients assumed by the business system 300, a performance deterioration event pattern which causes concentration of processing requests, a server failure event pattern such as software stop failure or hardware stop failure, and a system resource failure event pattern such as abnormality in the CPU, memory failure and disk failure.

In addition, simulation pattern data which the input unit 101 receives as an input is created based on, for example, past statistical data by, for example, the system administrator in advance before the throughput sustaining reference generating device 100 actually performs simulation. Further, the throughput sustaining reference generating device 100 receives an input of simulation pattern data created in advance and stores the simulation pattern data in the storage device 103 according to an input operation of, for example, the system administrator.

The pattern which uniformly produces processing requests matching the expected number of clients or performance deterioration event pattern data which causes concentration of processing requests include simulation parameters such as the number of clients, the maximum number of processing requests transmitted by one client at the same time, a transmission interval of one processing request and a maximum connection time of one processing request. For example, using these simulation parameters, it is possible to generate simulation pattern data of a processing request of each application per elapsed time in advance.

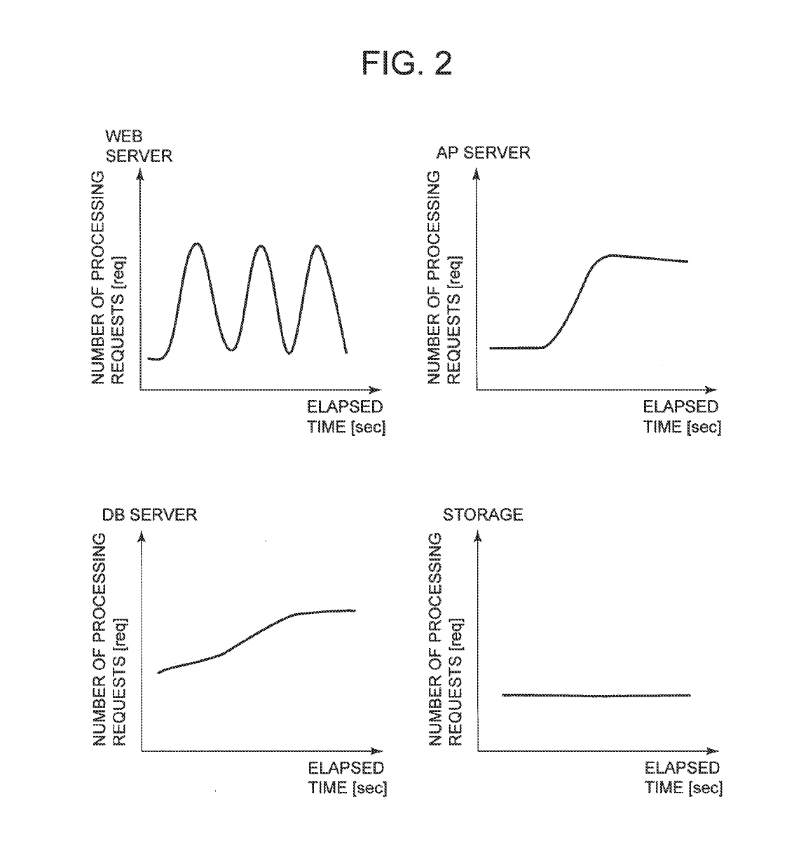

FIG. 2 is an explanatory view that illustrates an example of simulation pattern data which the input unit 101 receives as input. FIG. 2 illustrates, for example, simulation pattern data in the business system 300 including a web server 301, a web AP server 302, a DB server 303 and a storage 304, and each simulation pattern data includes information indicating the transition of the number of processing requests of each server per elapsed time. In addition, the simulation pattern data includes not only a pattern which uniformly produces (transitions) a processing request for each application of the business system 300, but also a pattern which is produced (changes) based on a normal distribution or a lognormal distribution.

Further, the server failure event pattern data and the system resource failure event pattern include simulation parameters such as an application of the business system 300 in which failure takes place, a failure type (software failure, hardware failure, CPU failure, memory failure, disk failure or network failure), an failure probability, the maximum number of failures and an increase rate of the number of processing requests of an application of a business system which is influenced by failure. By, for example, decreasing the number of processing requests of an application of the business system 300 in which failure takes place and increasing the number of processing requests of an application of the business system 300 which is influenced by failure among applications of the business system 300 which changes the number of processing requests per elapsed time, it is possible to create pattern data as server failure event pattern data. Further, a pattern listing and combining failures (hardware failure and software failure) which are highly likely to take place may be used as server failure event pattern data. In addition, the server failure event pattern data and the system resource failure event pattern are used in combination with the performance deterioration event pattern data when the throughput sustaining reference is generated.

In addition, for example, the throughput sustaining reference generating device 100 may use operation data of another business system which employs the same hardware configuration and software configuration as the business system 300 which is a generation target of the throughput sustaining reference as simulation pattern data.

In addition, a normal input unit for inputting a command to the throughput sustaining reference generating device 100 may also be used as the input unit 101, or a dedicated input unit which receives an input of data required to generate the throughput sustaining reference may be provided.

In addition, with the present embodiment, simulation refers to reproducing a state where a business system 300 provides a processing result to a client. In simulation, an application program of providing a processing result from the business system 300 to a client is run on system resources which the business system 300 can use. Further, the inputted simulation pattern data is produced.

The clock generating unit 102 is more specifically realized by a clock circuit of the information processing device. The clock generating unit 102 has a function of generating and outputting a clock signal used by the throughput sustaining reference generating device 100.

The storage device 103 is more specifically realized by a storage device such as a magnetic disk device or an optical disk device. The storage device 103 stores the simulation pattern data inputted by the input unit 101.

The throughput sustainability calculating unit 104 is more specifically realized by the CPU of the information processing device which operates according to the program. The throughput sustainability calculating unit 104 has a function of referring to simulation pattern data stored in the storage device 103, and calculating sustainability (hereinafter, also referred to as “throughput sustainability”) at which throughput expected by the business system 300 is sustained. Further, the throughput sustainability calculating unit 104 has a function of calculating a reference (throughput sustaining reference) for sustaining the throughput using the calculated throughput sustainability. Furthermore, the throughput sustainability calculating unit 104 has a function of outputting the calculated throughput sustaining reference using the transmitting/receiving unit 105.

The transmitting/receiving unit 105 is more specifically realized by a network interface unit of the information processing device. The transmitting/receiving unit 105 has, for example, a function of transmitting and receiving various items of data to and from the management server 200, the business system 300 and the resource pool 400 through the network 500 under control of the CPU of the information processing device.

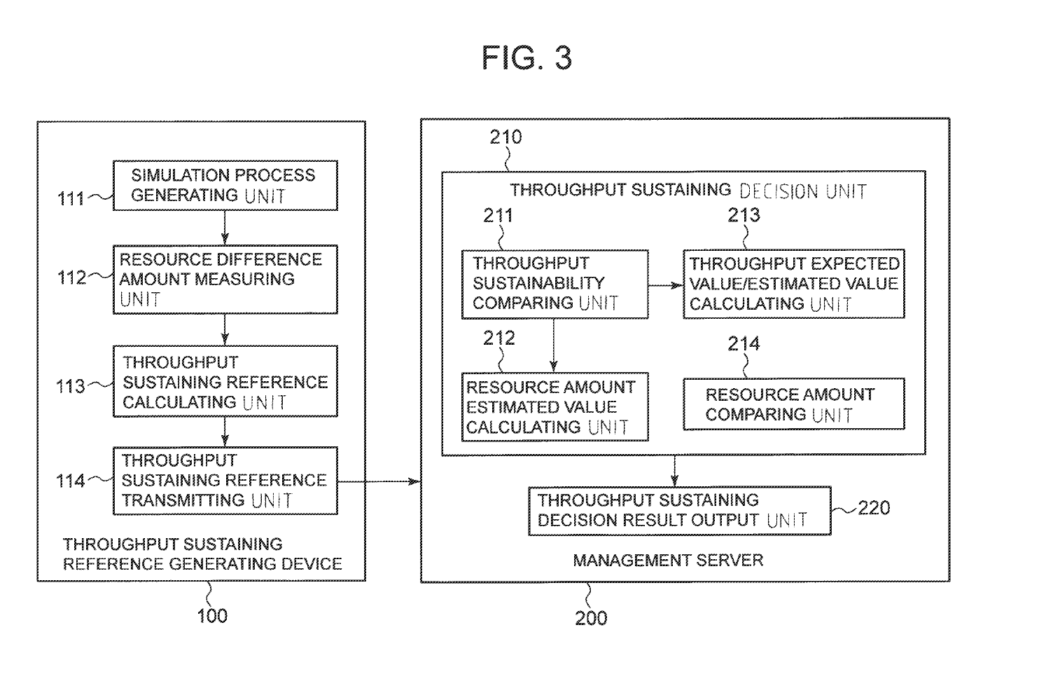

Next, a function configuration of the throughput sustaining support system illustrated in FIG. 1 will be described. FIG. 3 is a functional block diagram that illustrates a function configuration example of the throughput sustaining support system. As illustrated in FIG. 3, in the throughput sustaining support system, the throughput sustaining reference generating device 100 has a simulation process generating unit 111, a resource difference amount measuring unit 112, a throughput sustaining reference calculating unit 113 and a throughput sustaining reference transmitting unit 114. Further, the management server 200 includes a throughput sustaining decision unit 210 and a throughput sustaining decision result output unit 220.

The simulation process generating unit 111 is more specifically realized by the CPU of the information processing device which operates according to the program. The simulation process generating unit 111 has a function of generating simulation process.

The resource difference amount measuring unit 112 is more specifically realized by the CPU of the information processing device which operates according to the program, and a network interface unit. The resource difference amount measuring unit 112 has a function of executing simulation using the simulation process generated by the simulation process generating unit 111, and measuring the throughput of the business system 300 while changing the system resource amount of the business system 300. Further, the resource difference amount measuring unit 112 has a function of measuring a difference amount between a reference system resource amount required by the business system 300 to sustain a throughput expected value upon the expected number of processing requests in the business system 300, and the current system resource amount.

The throughput sustaining reference calculating unit 113 is more specifically realized by the CPU of the information processing device which operates according to the program. The throughput sustaining reference calculating unit 113 has a function of computing the sustainability at which the throughput measured by the resource difference amount measuring unit 112 can be sustained without exceeding the expected throughput value, based on the difference amount between the system resource amounts measured by the resource amount measuring unit 112, and calculating a reference value (throughput sustaining reference) for deciding whether or not the expected throughput value can be sustained, based on the computed sustainability at which the throughput can be sustained without exceeding the expected throughput value. With the present embodiment, the throughput sustaining reference calculating unit 113 computes a throughput sustaining density obtained by multiplying the throughput measured by the resource difference amount measuring unit 112 and a reciprocal of the sustainability at which the throughput can be sustained without exceeding the calculated throughput expected value. The throughput sustaining density is calculated per system resource amount upon measurement. Further, the throughput sustaining reference calculating unit 113 calculates the throughput sustaining density which has a maximum value among the calculated throughput sustaining densities as a reference value for deciding whether or not the expected throughput value can be sustained.

The throughput sustaining reference transmitting unit 114 is more specifically realized by the CPU of the information processing device which operates according to the program, and the network interface unit. The throughput sustaining reference transmitting unit 114 has a function of transmitting the throughput sustaining reference calculated by the throughput sustaining reference calculating unit 113, to the management server 200 through the network 500.

The throughput sustaining decision unit 210 is more specifically realized by the CPU of the information processing device which operates according to the program. The throughput sustaining decision unit 210 has a function of deciding whether or not the expected throughput value in the business system 300 can be sustained based on a simulation result expected by repeating processing of transmitting processing requests to the business system 300 and receiving processing results from the business system 300 using the expected throughput value in the business system 300 and simulation pattern data indicating a pattern of an operating situation of the business system 300. As illustrated in FIG. 3, the throughput sustaining decision unit 210 includes a throughput sustainability comparing unit 211, a resource amount estimated value calculating unit 212, a throughput expected value/estimated value calculating unit 213 and a resource amount comparing unit 214.

The throughput sustainability comparing unit 211 has a function of comparing the sustainability at which the throughput can be sustained without exceeding the expected throughput value when the system resource amount is added, and a predetermined threshold based on the reference value calculated by the throughput sustaining reference calculating unit 113.

The resource amount estimated value calculating unit 212 has a function of calculating the difference amount between system resource amounts when the throughput sustaining density calculated by the throughput sustaining reference calculating unit 113 has a maximum value as an estimated value of the optimal system resource amount which can sustain the expected throughput value. With the present embodiment, the resource amount estimated value calculating unit 212 calculates the system resource amount after the addition as the estimated value of the optimal system resource amount when the throughput sustainability comparing unit 211 decides that the sustainability at which the throughput can be sustained without exceeding the expected throughput value is a predetermined threshold or more.

The throughput expected value/estimated value calculating unit 213 has a function of calculating the expected throughput value after the addition of the system resource amount as the estimated value of the optimal throughput expected value when the throughput sustainability comparing means 211 decides that the sustainability at which the throughput can be sustained without exceeding the expected throughput value is a predetermined threshold or more.

The resource amount comparing unit 214 has a function of comparing the difference amount between the system resource amounts when the throughput sustaining density calculated by the throughput sustaining reference calculating unit 113 has the maximum value, and the current system resource of the business system 300.

The throughput sustaining decision result output unit 220 is more specifically realized by the CPU of the information processing device which operates according to the program and a display device such as a display apparatus. The throughput sustaining decision result output unit 220 has a function of outputting a decision result as to whether or not the expected throughput value decided by the throughput sustaining decision unit 210 can be sustained. With the present embodiment, the throughput sustaining decision result output unit 220 displays an addition alert that the system resource amount needs to be added when, for example, the resource amount comparing unit 214 decides that the system resource amount of the business system 300 runs out. Further, the throughput sustaining decision result output unit 220 displays a limitation alert that the system resource amount needs to be limited when, for example, the resource amount comparing unit 214 decides that the system resource amount of the business system 300 is surplus.

In addition, a method of outputting a decision result as to whether or not the expected throughput value can be sustained is by no unit limited to the method described in the present embodiment, and, for example, the throughput sustaining decision result output unit 220 may output data including the decision result as to whether or not the expected throughput value can be sustained as a file, broadcast the decision result by unit of sound, light, vibration or aroma or transmit the decision result to an external device through the network 500.

In addition, with the present embodiment, the storage devices of the throughput sustaining reference generating device 100 and the management server 200 store various programs for performing processing of supporting that the throughput in the business system 300 is sustained. For example, the storage device (not illustrated) of the management server 200 stores a throughput sustaining support program which causes a computer to execute: processing of deciding whether or not the expected throughput value can be sustained in a server system based on correspondence data (simulation result) between the throughput of the server system and a system resource surplus amount measured using the expected throughput value which is the throughput expected in advance for the server system (business system 300) and pattern data (simulation pattern data) which indicates a pattern of a processing request matching an operating situation of the server system; and processing of outputting a decision result as to whether or not the expected throughput value can be sustained.

Further, for example, the storage device 103 of the throughput sustaining reference generating device 100 stores the program which causes the computer to execute: processing of generating simulation process; processing of measuring the throughput of the server system while executing simulation using the generated simulation process and changing a system resource amount of the server system, and measuring a difference amount between a reference system resource amount which the server system requires to sustain the expected throughput value upon the expected number of processing requests in the server system, and a current system resource amount; and processing of computing the sustainability at which the measured throughput can be sustained without exceeding the expected throughput value, based on the measured difference amount between the system resource amounts, and calculating a reference value for deciding whether or not the expected throughput value can be sustained, based on the computed sustainability at which the throughput can be sustained without exceeding the expected throughput value.

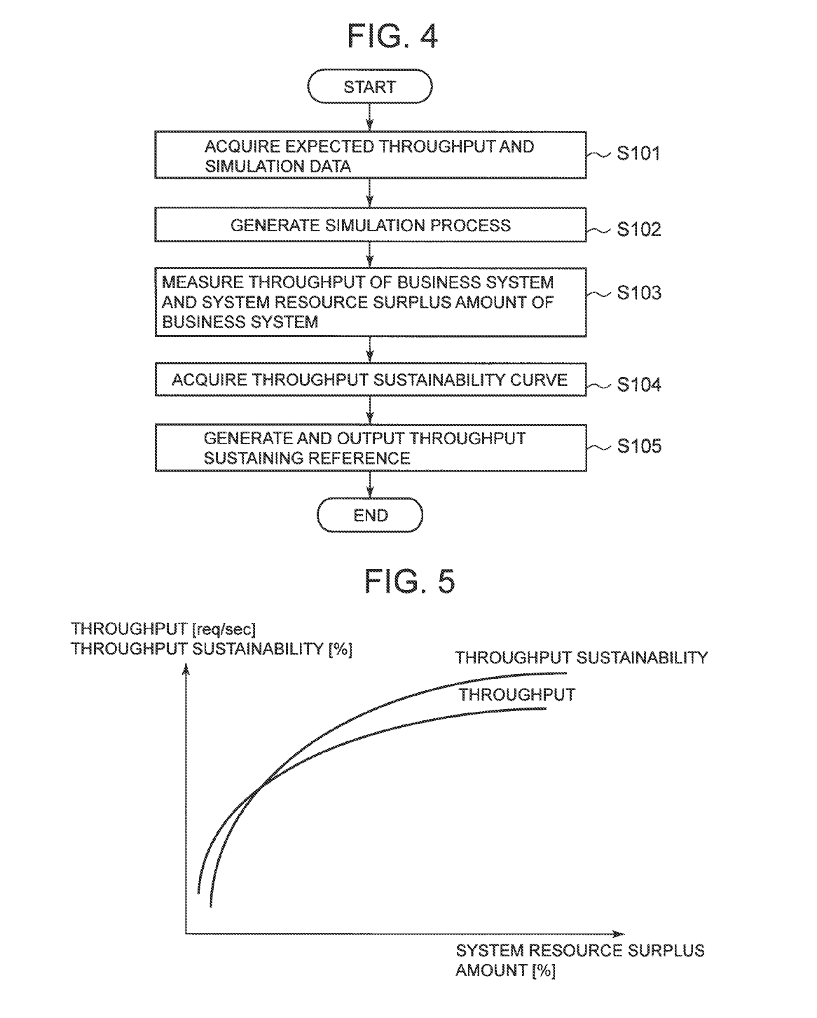

Next, an operation will be described. First, the operation of the business system 300 of generating and outputting a throughput sustaining reference will be described. FIG. 4 is a flowchart that illustrates a processing example of the business system 300 of generating and outputting a throughput sustaining reference. In addition, processing of generating the throughput sustaining reference of the business system 300 illustrated in FIG. 4 is preprocessing performed by, for example, a system administrator in advance before the business system 300 is used for business (processing performed using predetermined test environment in advance).

Further, with the present embodiment, before the throughput sustaining reference generation processing illustrated in FIG. 4 is executed, the expected throughput value or the simulation pattern data is inputted in advance by operating the input unit 101 by, for example, the system administrator, and is stored in the storage device 103. In addition, with the present embodiment, a value which is determined in advance based on, for example, a contract between a service provider which provides throughput sustaining support service and a user who uses the business system 300 is inputted as the expected throughput value, and is stored in the storage device 103. Further, at, for example, a timing when throughput sustaining reference generation processing illustrated in FIG. 4 is started, the expected throughput value or simulation pattern data may be inputted, and the throughput sustaining reference may be created using the inputted throughput expected value and simulation pattern data.

First, the throughput sustaining reference generating device 100 acquires the throughput expected by the business system 300, and pattern data of simulation of the business system (step S101). For example, the throughput sustaining reference generating device 100 extracts the expected throughput value and the simulation pattern data stored in the storage device 103.

Next, the throughput sustaining reference generating device 100 generates simulation process of the business system 300 (step S102). In addition, the simulation process of the business system 300 is processing of repeatedly allocating system resources to an application of the business system 300, then transmitting the processing request to the application of the business system 300 and receiving a processing result of the business system 300.

Next, the throughput sustaining reference generating device 100 measures the throughput of the business system 300 and the system resource surplus amount of the business system 300 while changing the system resource amount of the business system 300 in the simulation process of the business system 300, and stores the measuring results in the storage device 103 (step S103). Consequently, it can be said that the storage device 103 stores the measured throughput and system resource surplus amount in association.

In addition, changing the system resource amount is to change a server which is system resources or an arbitrary combination of the CPU, the memory, the storage and the network. Further, the system resource surplus amount is, for example, a surplus amount 0[%] when the expected throughput acquired in step S101 is measured according to a pattern which produces processing requests matching the expected number of clients. Furthermore, the difference between the system resource amount (reference value) when the system resource surplus amount is 0[%] and the changed system resource amount is represented as the changed system resource surplus amount.

When, for example, expected throughput 30 [req/sec] is measured by a system resource when one virtual server is allocated to each of the web server 301, the web AP server 302, the DB server 303 and the storage 304, the system resource surplus amount in this case is 0[%]. Further, a case will be described where system resources are changed when one virtual server is allocated to each of the web server 301 and the web AP server 302 and two virtual servers are allocated to each of the DB server 303 and the storage 304. In this case, the system resource surplus amount is expressed in such a way that there are two more virtual servers compared to a case where the system resource surplus amount is 0[%].

In addition, in the above case, a method of expressing the system resource surplus amount may express that, for example, “there are two more virtual servers”. Further, the system resource surplus amount is 0[%] when, for example, four virtual servers are used, and the system resource surplus amount may be expressed as “50[%]” when six virtual servers are used.

Next, the throughput sustaining reference generating device 100 refers to data stored in the storage device 103 (measurement data measured in step S103), and acquires (calculates) a throughput sustainability curve (step S104). In addition, the throughput sustainability refers to sustainability at which throughput at a point of time can be sustained without exceeding the expected throughput with respect to the system resource surplus amount.

When, for example, the system resource surplus amount is 10[%], the throughput sustaining reference generating device 100 measures throughput at this point of time in step S103 by producing pattern data of simulation such as the pattern which uniformly produces processing requests matching the expected number of clients, the performance deterioration event pattern which causes concentration of processing requests, a software failure event pattern and a hardware failure event pattern. Further, when computing the throughput sustainability in step S104, the throughput sustaining reference generating device 100 calculates a numerical value when the measured throughput is the expected throughput value or more acquired in step S101. For example, the throughput sustaining reference generating device 100 computes the throughput sustainability as 50[%] when the throughput which is the expected throughput value or more is measured five times out of ten times. Further, the throughput sustaining reference generating device 100 acquires (calculates) the throughput sustainability curve by associating the throughput sustainability curve with the system resource surplus amount stored in the storage device 103 and plotting the computed throughput sustainability of the business system 300.

Hereinafter, a throughput sustainability curve will be described using drawings. FIG. 5 is an explanatory view that illustrates a relationship between a system resource surplus amount, throughput and a throughput sustainability. As illustrated in FIG. 5, although the throughput increases in proportion to an increase in the system resource surplus amount, if the system resource surplus amount increases too much, the system resources become excessive, and therefore the degree of increase gradually becomes small and eventually levels off.

Further, as illustrated in FIG. 5, a value of the throughput sustainability is small at a first state at which the system resource surplus amount is small. That is, system resources frequently run out when processing requests concentrate, and software failure or hardware failure takes place, and therefore the expected throughput cannot be usually sustained and the throughput sustainability becomes small. Meanwhile, when the system resource surplus amount increases, even if processing requests concentrate or software failure or hardware failure takes place, the system resources do not run out, so that the expected throughput can be usually sustained and the throughput sustainability gradually increases. However, even when the system resource surplus amount increases too much, the throughput expected upon critical system failure cannot be sustained in some cases, and therefore the degree of increase in the throughput sustainability gradually becomes small and eventually levels off.

Next, the throughput sustaining reference generating device 100 calculates the throughput sustaining density based on the throughput sustainability computed in step S104. Further, the throughput sustaining reference generating device 100 outputs (transmits) the throughput sustaining density having the maximum value among the computed throughput sustaining densities to the management server 200 through the network 500 as the throughput sustaining reference (step S105). In addition, the method of outputting the throughput sustaining reference is by no unit limited to the method described in the present embodiment, and, for example, the throughput sustaining reference generating device 100 may display the computed throughput sustaining reference on a display device such as a display apparatus and output data including the computed throughput sustaining reference as a file.

In addition, the throughput sustaining density is a value obtained by multiplying the throughput and the reciprocal of the throughput sustainability, and refers to an expectation at which the throughput can be sustained. The throughput sustaining reference generating device 100 acquires (calculates) the throughput sustaining density curve using the throughput sustainability curve acquired in step S104, and computes the throughput sustaining density having the maximum value as the throughput sustaining reference.

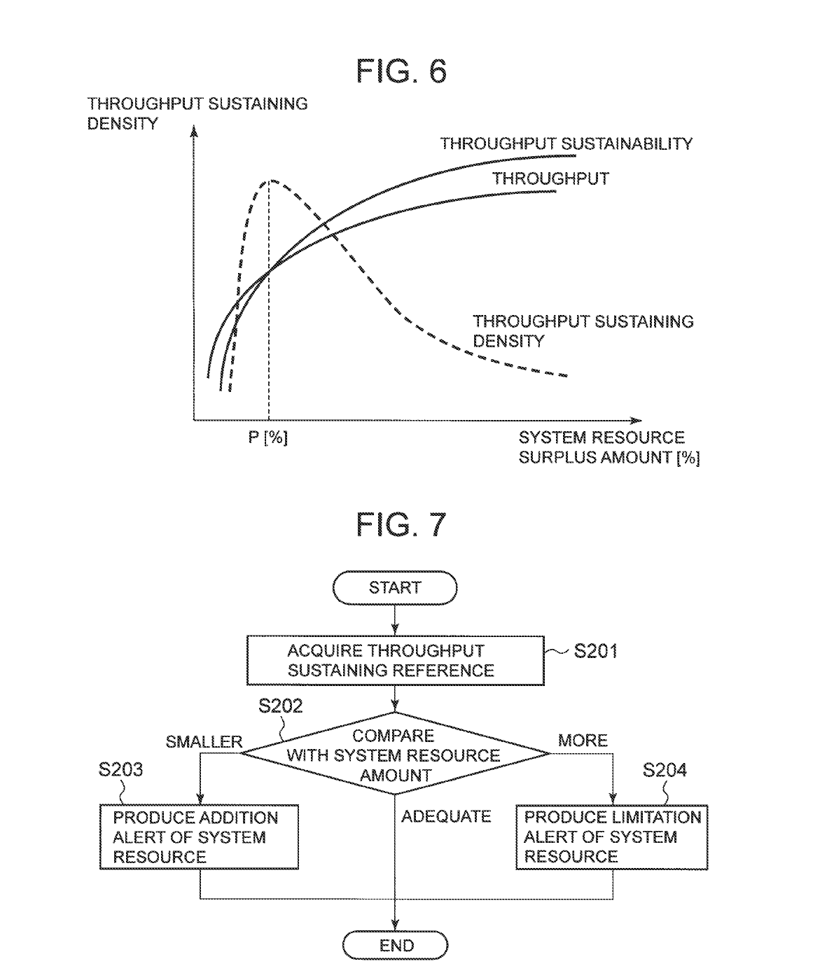

FIG. 6 is an explanatory view that illustrates a relationship between the system resource surplus amount, the throughput, the throughput sustainability and the throughput sustaining density. With an example illustrated in FIG. 6, when the system resource surplus amount (a surplus amount p [%] illustrated in FIG. 6) has the maximum value of the throughput sustaining density, an expectation at which the throughput can be sustained in the system resource surplus amount becomes the largest. That is, the system resource surplus amount having the maximum value of the throughput sustaining density has a value at which the throughput can be sustained the most efficiently.

After the throughput sustaining reference generating device 100 calculates the throughput sustaining reference, the management server 200 performs control to sustain the expected throughput value of the business system 300 by, for example, using the throughput sustaining reference from the throughput sustaining reference generating device 100 and performing resource allocation processing. With the present embodiment, the management server 200 can easily learn whether or not the expected throughput can be sustained by using the throughput sustaining reference from the throughput sustaining reference generating device 100 and the system resource surplus amount easily learned on the management server 200 side in advance. That is, the management server 200 can learn in advance the optimal system resource surplus amount at which the throughput expected by the business system 300 can be sustained, and add insufficient system resources or limit surplus system resources.

FIG. 7 is a flowchart that illustrates an example of processing of the management server 200 of evaluating whether or not a throughput expected value can be sustained. In addition, the evaluation processing illustrated in FIG. 7 is processing executed by the management server 200 at a timing when the client makes a use request of the business system 300. Further, the management server 200 receives from the throughput sustaining reference generating device 100 an input of the throughput sustaining reference computed in advance by the throughput sustaining reference generating device 100, and stores the throughput sustaining reference. In addition, the management server 200 receives an input of each of throughput sustaining references computed for a plurality of types of throughput expected values, and associates and stores the expected throughput values and the throughput sustaining references in advance in the storage device.

When whether or not the expected throughput value in the business system 300 can be sustained is evaluated, for example, the system administrator performs an operation of inputting the maximum value of the expected throughput (the maximum number of processing requests of the expected number of clients) and the current system resource surplus amount using the management server 200. Then, the management server 200 receives an input of the maximum value of the expected throughput and the current system resource surplus amount according to, for example, a system administrator's input operation, and starts the evaluation processing.

Next, the management server 200 acquires the throughput sustaining reference associated with the maximum value of the expected throughput (S201). More specifically, the management server 200 extracts the throughput sustaining reference associated with the maximum value of the expected throughput (throughput expected value) from the storage device. Next, the management server 200 compares the system resource surplus amount associated with the throughput sustaining reference acquired in step S201, and the system resource surplus amount inputted when the evaluation processing starts (step S202).

When deciding that the system resource surplus amount associated with the throughput sustaining reference acquired in step S201 is smaller than the system resource surplus amount inputted when the evaluation processing starts, the management server 200 decides that the expected throughput value cannot be sustained and therefore system resources run out. Further, the management server 200 produces an alert that insufficient system resources are added (step S203). For example, the management server 200 displays the alert that the system resources need to be added, on the display device such as the display apparatus. In addition, the system resource surplus amount is the amount of system resources which is a surplus when given throughput is realized among system resources of the business system 300. Although an example will be described with the present embodiment where it is decided that system resources are insufficient when +0[%] of the system resource surplus amount is a minimum value and the system resource surplus amount is small, it may be decided that system resources run out when −0[%] of the system resource surplus amount is a maximum value and the system resource surplus amount is large.

Meanwhile, when deciding that the system resource surplus amount associated with the throughput sustaining reference acquired in step S201 is larger than the system resource surplus amount inputted when the evaluation processing starts, the management server 200 decides that the system resources are surplus. Further, the management server 200 produces an alert that surplus system resources are limited (step S204). For example, the management server 200 displays an alert that system resources need to be limited, on the display device such as the display apparatus.

Further, the management server 200 decides that the current system resource amount is adequate when the system resource surplus amount associated with the throughput sustaining reference acquired in step S201 matches with the system resource surplus amount inputted when the evaluation processing starts, and finishes the processing as is. In addition, for example, the management server 200 may display a notice that the system resource amount is adequate, on the display device such as the display apparatus.

In addition, when the evaluation processing illustrated in FIG. 7 is executed, if the maximum value of the expected throughput (the maximum number of processing requests of the expected number of clients) inputted when the evaluation processing starts exceeds an actual throughput value, preferably, the maximum value of the expected throughput is set again to the actual throughput value or more, the throughput sustaining reference is acquired again and the evaluation processing illustrated in FIG. 7 is executed.

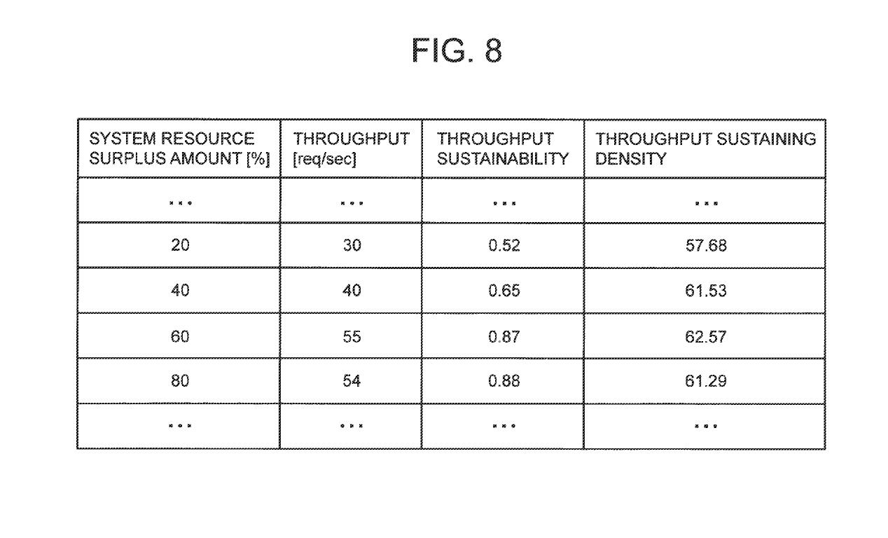

A specific example of the evaluation processing performed by the management server 200 will be described using the drawings. FIG. 8 is an explanatory view that illustrates a specific example of the system resource surplus amount, the throughput, the throughput sustainability and a throughput sustaining density. In addition, in simulation performed by the above throughput sustaining reference generating device 100, an example illustrated in FIG. 8 is acquired based on the throughput sustainability curve of the business system 300 computed from the result that the maximum value of the expected throughput is 60 [req/sec].

With a data example illustrated in FIG. 8, when the system resource surplus amount is 60[%], the throughput sustaining density of the business system is 62.57 which is the maximum value, and a value of 0.87 is obtained for the throughput sustainability at this point of time. Hence, with the example illustrated in FIG. 8, the throughput sustaining generating device 100 outputs the throughput sustainability to the management server 200 based on the throughput sustaining reference that the system resource surplus amount is 60[%].

More specifically, although the throughput sustainability is 0.87 or more when the system resource surplus amount exceeds 60[%] with the example illustrated in FIG. 8, the system resources are not used as long as critical system failure does not take place. That is, in a state where the system resource surplus amount substantially exceeds 60[%], the system resources become rather excessive. Meanwhile, when the system resource surplus amount is less than 60[%], while the state where the system resources are excessive is canceled, the throughput sustainability decreases, and the expected throughput is gradually more likely not to be sustained.

With the example illustrated in FIG. 8, the throughput sustainability is 0.52 when the system resource surplus amount is 20[%], the throughput sustainability is 0.65 when the system resource surplus amount is 40[%], and the throughput sustainability is 0.88 is when the system resource surplus amount is 80[%]. With the example illustrated in FIG. 8, the management server 200 can produce an alert that insufficient system resources are added when the system resource surplus amount is 20[%] or 40[%] which is less than 60[%]. Meanwhile, when the system resource surplus amount is 80[%] which is more than 60[%], the management server 200 can produce an alert that surplus system resources are limited.

In addition, the management server 200 may not only simply produce an alert but also perform control to add or limit the system resource amount using preliminary resources in the resource pool 400 based on an evaluation result as to whether or not the expected throughput can be sustained. In this case, when, for example, producing an alert that system resources are added, the provisioning event generation unit 201 of the management server 200 may generate a provisioning event for commanding an addition of the system resource amount. Further, when producing an alert that system resources are limited, the provisioning event generation unit 201 may generate a provisioning event for commanding limitation of the system resource amount.

Generally, when the system resources for the business system 300 run out, a decrease in the throughput of the business system 300 is notified in response to a claim from a user, and, for example, the system administrator handles, for example, a change of resource allocation. By contrast with this, with the present embodiment, by alerting to the system administrator that the probability that the throughput cannot be sustained increases, it is possible to notify insufficient resources to, for example, the system administrator in advance, and, for example, the system administrator can increase system resources to sustain the throughput. Consequently, the user can sustain comfortable throughput at all times and enjoy service without particularly caring shortage of the system resources.

Further, with the present embodiment, by not only simply producing an alert but also using the preliminary system resource amount which the management server 200 side can easily learn in advance, the management server 200 can estimate the required preliminary system resource amount to sustain the throughput expected by the business system 300.

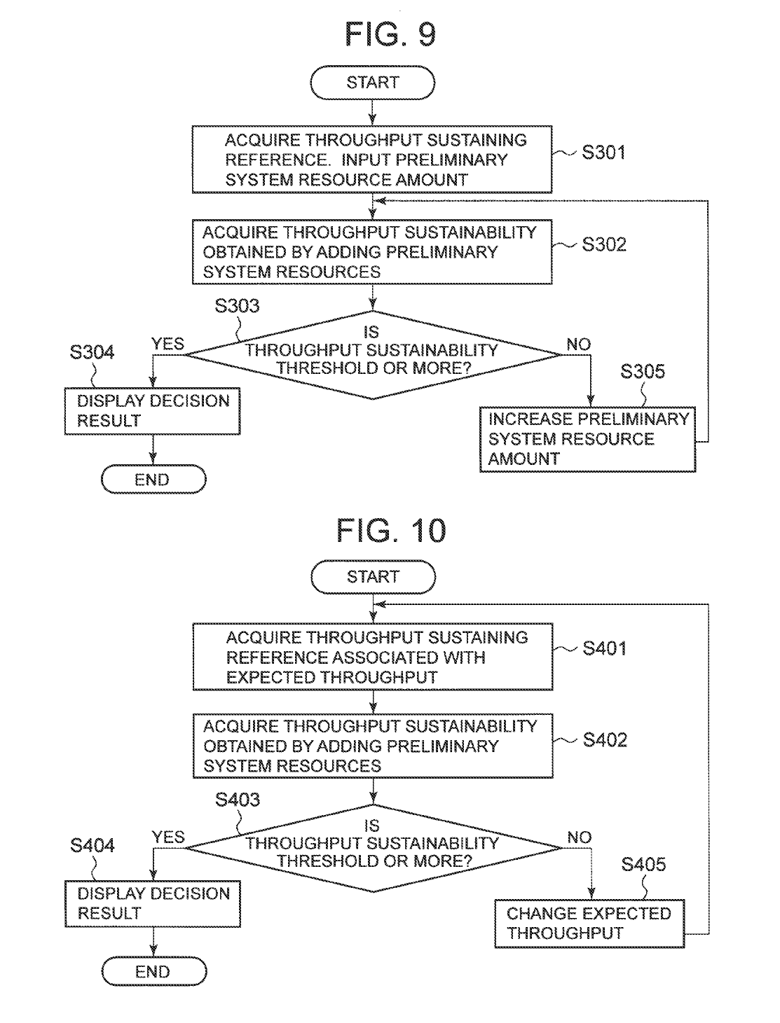

FIG. 9 is a flowchart that illustrates an example of resource amount estimation processing of the management server 200 of estimating a required system resource amount. In addition, the resource amount estimation processing illustrated in FIG. 9 is also processing executed by the management server 200 at a timing when the client makes a use request of the business system 300.

In addition, the resource amount estimation processing illustrated in FIG. 9 will be described below using a specific data example illustrated in FIG. 8. In addition, as described above, in simulation performed by the above throughput sustaining reference generating device 100, an example illustrated in FIG. 8 is acquired based on the throughput sustainability curve of the business system 300 computed from the result that the maximum value of the expected throughput is 60 [req/sec].

When the system resource amount required in the business system 300 is estimated, for example, the system administrator performs an operation of inputting the maximum value of the expected throughput (the maximum number of processing requests of the expected number of clients), the estimated system resource surplus amount and the threshold of the throughput sustainability using the management server 200. Then, the management server 200 receives an input of the maximum value of the expected throughput, the estimated system resource surplus amount and the threshold of the throughput sustainability according to, for example, a system administrator's input operation, and starts the resource amount estimation processing. For example, the management server 200 receives an input of 60 [req/sec] as the maximum value of the expected throughput, and receives an input of 40 [req/sec] as the estimated system resource surplus amount. Further, the management server 200 receives an input of 0.8 as the threshold of the throughput sustainability, and starts the resource amount estimation processing.

Next, the management server 200 acquires (for example, extracts from the storage device) the throughput sustaining reference, and receives an input of 20[%] as the preliminary system resource amount (step S301). For example, with the data example illustrated in FIG. 8, when the preliminary system resource amount is added, the system resource surplus amount is 60[%], and the management server 200 acquires 0.87 as the throughput sustainability associated with the maximum value of the expected throughput (for example, converts and calculates 0.87 from the throughput sustaining reference) (step S302). Next, the management server 200 compares the throughput sustainability obtained in step S302, and the threshold of the throughput sustainability inputted when the resource amount estimation processing starts (step S303).

With the above example, the management server 200 decides that the throughput sustainability obtained in step S302 is the threshold of the throughput sustainability inputted when the resource amount estimation processing starts or more, decides that the system resource amount is adequate and displays on the display device such as the display apparatus a decision result that the preliminary system resource amount is 20[%] and the throughput sustainability of 0.8 or more is obtained (step S304).

Meanwhile, when deciding that the throughput sustainability is less than the threshold of the throughput sustainability inputted when the resource amount estimation processing starts in step S303, the management server 200 decides that the system resource amount runs out and the preliminary system resource amount is increased (step S305). Further, the management server 200 proceeds to step S302, and repeatedly executes processing subsequent to step S302 until a decision result equal to or more than the threshold of the throughput sustainability inputted when the resource amount estimation processing starts is obtained.

In addition, when the resource amount estimation processing illustrated in FIG. 9 is executed, if the maximum value of the expected throughput (the maximum number of processing requests of the expected number of clients) inputted when the resource amount estimation processing starts exceeds an actual throughput value, preferably, the maximum value of the expected throughput is set again to the actual throughput value or more, the throughput sustaining reference is acquired again and the resource amount estimation processing illustrated in FIG. 9 is executed.

In addition, although a case has been described with the present embodiment where an estimation result of the optimal system resource amount is calculated by repeating comparison processing while increasing the preliminary system resource amount when it is decided that the system resource amount runs out in the resource amount estimation processing, a way to estimate the system resource amount is not limited to the way described in the present embodiment. For example, instead of the method illustrated in FIG. 9 or together with the method illustrated in FIG. 9, by repeating comparison processing while decreasing the system resource amount on the contrary when it is decided that the system resource amount is excessive, the estimation result of the optimal system resource amount may be calculated. Meanwhile, software failure or hardware failure takes place and therefore it is decided in some cases that the system resource amount is excessive, and, when software failure or hardware failure takes place, the estimation result of the system resource amount is preferably calculated without decreasing the system resource amount.

Further, with the present embodiment, by estimating to what extent the throughput can be sustained based on the preliminary system resource amount which, for example, the system administrator can use, the system administrator can estimate the expected throughput.

FIG. 10 is a flowchart that illustrates an example of throughput value estimation processing of the management server 200 of estimating the expected throughput value. In addition, the evaluation processing illustrated in FIG. 10 is processing executed by the management server 200 at a timing when the client makes a use request of the business system 300.

In addition, the throughput value estimation processing illustrated in FIG. 10 will be described below using a specific data example illustrated in FIG. 8. In addition, as described above, in simulation performed by the above throughput sustaining reference generating device 100, an example illustrated in FIG. 8 is acquired based on the throughput sustainability curve of the business system 300 computed from the result that the maximum value of the expected throughput is 60 [req/sec].

When the expected throughput value in the business system 300 is estimated, for example, the system administrator performs an operation of inputting the expected throughput and the threshold of the throughput sustainability using the management server 200. Then, the management server 200 receives, for example, an input of 60 [req/sec] as the expected throughput according to, for example, a system administrator's input operation, receives an input of 0.8 as the threshold of the throughput sustainability and starts the throughput value estimation processing.

Next, the management server 200 acquires (for example, extracts from the storage device) the throughput sustaining reference generated based on the expected throughput (step S401). Next, the management server 200 acquires (for example, converts and calculates from the throughput sustaining reference) the throughput sustainability obtained by adding the preliminary system resources. For example, when the system resource surplus amount is 40[%], the management server 200 obtains 0.65 as the throughput sustainability (step S402). Next, the management server 200 compares the throughput sustainability obtained in step S302, and the threshold of the throughput sustainability inputted when the throughput value estimation processing starts (step S403).

With the above example, the throughput sustainability obtained in step S302 is less than the threshold of the throughput sustainability inputted when the throughput value estimation processing starts, the management sever 200 decides that the expected throughput value is excessive and decreases the expected throughput (step S405). For example, the management server 200 decreases the expected throughput to 30 [req/sec]. Further, the management server 200 proceeds to step S401, and repeatedly executes processing subsequent to step S401 until a decision result equal to or more than the threshold of the throughput sustainability inputted when the throughput value estimation processing starts is obtained.

More specifically, the management server 200 executes processing in step S401 again, and acquires the throughput sustaining reference generated based on the expected throughput updated in step S405. Next, the management server 200 executes processing in step S402 again, and acquires the throughput sustainability associated with 40[%] which is the system resource surplus. The acquired throughput sustainability and the threshold of the throughput sustainability are compared. Next, the management server 200 executes processing in step S403 again and, if it is possible to decide that the acquired throughput sustainability is 0.8 or more (YES in step S403), displays on the display device such as the display apparatus a decision result that 0.8 or more of the throughput sustainability can be obtained by decreasing the expected throughput to 30 [req/sec] (step S404).

In addition, when the throughput value estimation processing illustrated in FIG. 10 is executed, if the maximum value of the expected throughput (the maximum number of processing requests of the expected number of clients) inputted when the throughput value estimation processing starts exceeds an actual throughput value, preferably, the maximum value of the expected throughput is set again to the actual throughput value or more, the throughput sustaining reference is acquired again and the throughput value estimation processing illustrated in FIG. 10 is executed.

As described above, according to the present embodiment, by performing simulation using simulation pattern data which also reflects an operating situation of the server system (business system 300) such as software failure or hardware failure, the throughput sustaining reference is created based on the simulation result. Further, whether or not the expected throughput value can be sustained is decided based on the throughput sustaining reference, and the decision result is outputted. Consequently, it is possible to support that the throughput is stably sustained taking various operating situations of a system into account. That is, according to the present embodiment, by calculating the sustaining reference of the expected throughput taking into account not only that the server system normally operates but also an event that the system becomes abnormal such as software failure or hardware failure takes place, it is possible to support that the throughput can be stably sustained.

In other words, according to the present embodiment, by computing an index of a desirable system resource amount which can sustain the expected throughput according to the relationship between the throughput and the throughput sustainability, it is possible to learn the system resource amount which can sustain the expected throughput and adjust the preliminary system resources prepared in advance.

Generally, whether or not the expected throughput can be sustained is not clear, and therefore more system resources need to be prepared. By contrast with this, according to the present embodiment, for example, the system administrator can learn in advance whether or not the system resource amount can sustain the throughput expected by the server system (business system 300). Further, in case of the system resource amount which cannot sustain the throughput expected by this server system (business system 300), an alert that the system resources run out is produced in advance. Furthermore, when there is a surplus system resource amount to sustain the throughput expected by this server system, an alert that system resources need to be limited is produced in advance. By so doing, it is possible to operate the server system (business system 300) such that the expected throughput can be sustained.

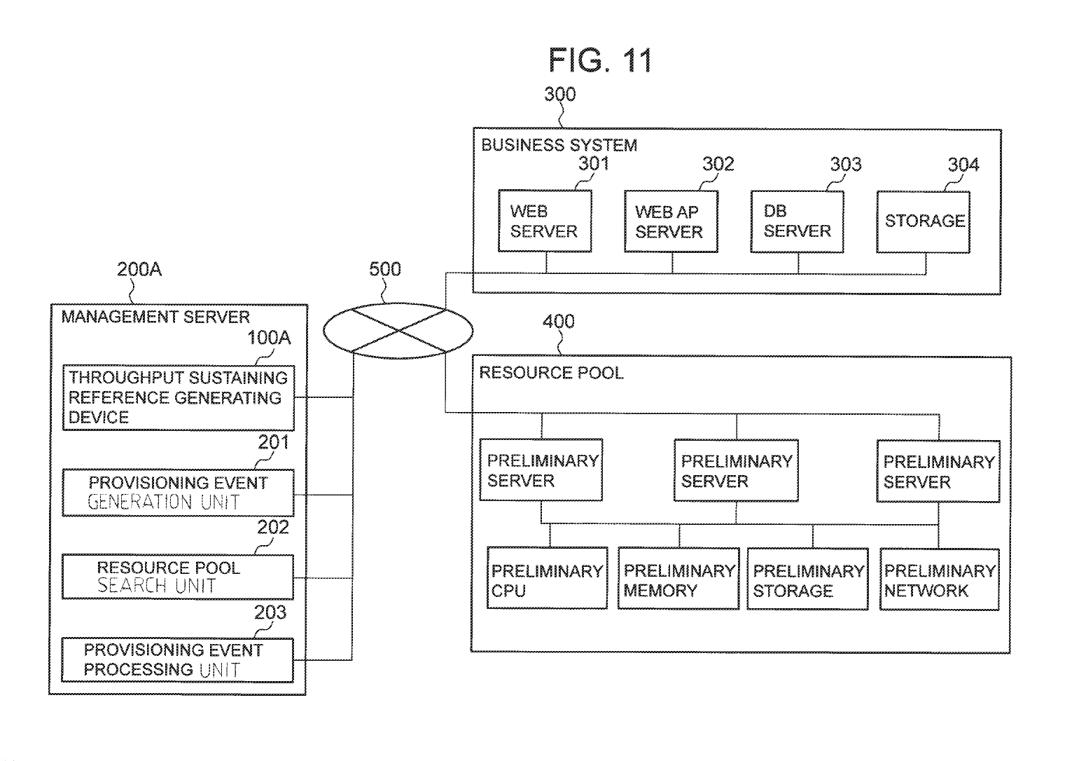

In addition, a way to configure the throughput sustaining support system is by no unit limited to the present embodiment. FIG. 11 is a block diagram that illustrates another configuration example of the throughput sustaining support system. As illustrated in FIG. 11, for example, a throughput sustaining reference generating device 100A may be included in a management server 200A (corresponding to the throughput sustaining support device). In addition, in FIG. 11, the function of the throughput sustaining reference generating device 100A is the same as the function of the throughput sustaining reference generating device 100 illustrated in FIG. 1, and functions of other unit 201, 202 and 203 of the management server 200A are the same as the functions of those illustrated in FIG. 13. Further, functions of the business system 300 and the resource pool 400 are the same as the functions of those illustrated in FIG. 13.

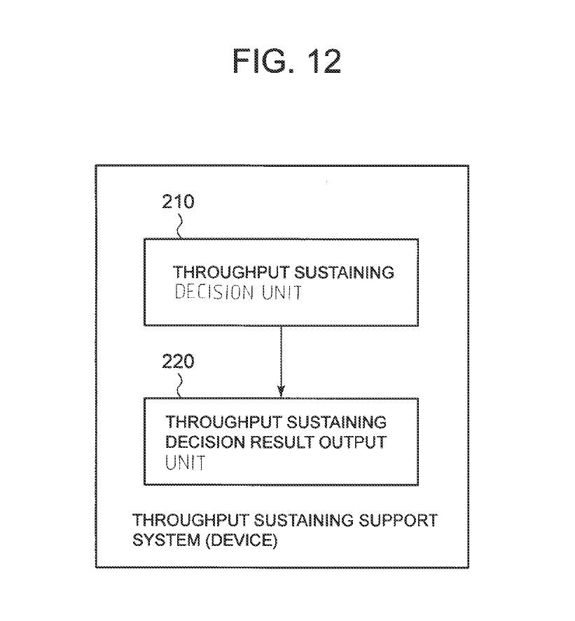

Next, a minimum configuration of the throughput sustaining support system (device) according to the present invention will be described. FIG. 12 is a functional block diagram that illustrates a minimum function configuration example of the throughput sustaining support system (device). As illustrated in FIG. 12, the throughput sustaining support system (device) has the throughput sustaining decision unit 210 and the throughput sustaining decision result output unit 220 as minimum components.

The throughput sustaining decision unit 210 has a function of deciding whether or not the expected throughput value can be sustained in a server system based on correspondence data between the throughput of the server system and a system resource surplus amount measured using the expected throughput value which is the throughput expected in advance for the server system and pattern data which indicates a pattern of a processing request matching an operating situation of the server system. Further, the throughput sustaining decision result output unit 220 has a function of outputting a decision result as to whether or not the expected throughput value decided by the throughput sustaining decision unit 210 can be sustained.

The throughput sustaining support system (device) employing the minimum configuration illustrated in FIG. 12 can support that the throughput can be stably sustained by taking various operating situations of the system into account.

In addition, with the above embodiment, characteristic configurations of the throughput sustaining support system and the throughput sustaining support device described in following (1) to (32) are described.

(1) A throughput sustaining support system has: a throughput sustaining decision unit (realized by, for example, the throughput sustaining decision unit 210) which decides whether or not throughput can be sustained without exceeding a throughput expected value in a server system based on correspondence data (for example, the simulation result) between a throughput value of the server system and a surplus amount of a system resource measured using the expected throughput value which is the throughput value expected upon the number of requests in advance for the server system (for example, the business system 300) and pattern data (for example, the simulation pattern data) which indicates a pattern of a processing request matching an operating situation of the server system; and a decision result output unit (realized by, for example, the throughput sustaining decision result output unit 220) which outputs a decision result as to whether or not the throughput can be sustained without exceeding the expected throughput value decided by the throughput sustaining decision unit.

(2) The throughput sustaining support system may employ a configuration which includes: a simulation process generating unit (realized by, for example, the simulation process generating unit 111) which generates simulation process for executing simulation by repeating processing of transmitting a processing request matching the pattern indicated by the pattern data to the server system and receiving a processing result from the server system using the expected throughput value and the pattern data; a resource difference amount measuring unit (realized by, for example, the resource difference amount measuring unit 112) which measures the throughput value of the server system while executing simulation using the simulation process generated by the simulation process generating unit and changing a system resource amount of the server system, and measures a difference amount between a reference system resource amount which the server system requires to sustain the throughput such that the throughput does not exceed the expected throughput value upon the expected number of processing requests in the server system, and a current system resource amount; and a reference value calculating unit (realized by, for example, the throughput sustaining reference calculating unit 113) which computes a sustainability at which throughput measured by the resource difference amount measuring unit can be sustained without exceeding the expected throughput value, based on the difference amount in the system resource amount measured by the resource difference amount measuring unit, and calculates a reference value (for example, the throughput sustaining reference) for deciding whether or not the throughput can be sustained without exceeding the expected throughput value, based on the obtained sustainability at which the throughput can be sustained without exceeding the expected throughput value, and in which the throughput sustaining decision mean decides whether or not the throughput can be sustained without exceeding the expected throughput value in the server system, based on the reference value calculated by the reference value calculating unit.

(3) The throughput sustaining support system may employ a configuration where the reference value calculating unit computes throughput sustaining densities obtained by multiplying a throughput value measured by the resource difference amount measuring unit and a reciprocal of the sustainability at which the throughput can be sustained without exceeding the calculated throughput expected value, and calculates a throughput sustaining density of the computed throughput sustaining densities which has a maximum value as a reference value for deciding whether or not the throughput can be sustained without exceeding the expected throughput value.

(4) The throughput sustaining support system may employ a configuration where the throughput sustaining decision unit includes a resource amount estimated value calculating unit (realized by, for example, the resource amount estimated value calculating unit 212) which calculates a difference amount in a system resource amount when the throughput sustaining density calculated by the reference value calculating unit has a maximum value as an estimated value of an optimal system resource amount at which the throughput can be sustained without exceeding the expected throughput value.

(5) The throughput sustaining support system may employ a configuration where the throughput sustaining decision unit includes a sustainability comparing unit (realized by, for example, the throughput sustainability comparing unit 211) which compares a sustainability at which the throughput can be sustained without exceeding the expected throughput value when a system resource amount is added, and a predetermined threshold based on the reference value calculated by the reference value calculating unit, and the resource amount estimated value calculating unit calculates a system resource amount after the addition as an estimated value of an optimal system resource amount when the sustainability comparing unit decides that the sustainability at which the throughput can be sustained without exceeding the expected throughput value is the predetermined threshold or more.

(6) The throughput sustaining support system may employ a configuration where, when deciding that the sustainability at which the throughput can be sustained without exceeding the expected throughput value is not a predetermined value or more, the sustainability comparing unit repeatedly executes processing of comparing the sustainability at which the throughput can be sustained without exceeding the expected throughput value when a system resource amount is further added, and a predetermined threshold.

(7) The throughput sustaining support system may employ a configuration where the throughput sustaining decision unit includes a resource amount comparing unit (realized by, for example, the resource amount comparing unit 214) which compares a difference amount in a system resource amount when the throughput sustaining density calculated by the reference value calculating unit has a maximum value, and a system resource upon decision in the server system, and when the resource amount comparing unit decides that the system resource amount of the server system runs out, the decision result output unit outputs an addition alert that a system resource amount needs to be added, and when the resource amount comparing unit decides that the system resource amount of the server system is surplus, outputs a limitation alert that a system resource amount needs to be limited.

(8) The throughput sustaining support system may employ a configuration where the throughput sustaining decision unit includes a sustainability comparing unit (realized by, for example, the throughput sustainability comparing unit 211) which compares a sustainability at which the throughput can be sustained without exceeding the expected throughput value when a system resource amount is added, and a predetermined threshold based on the reference value calculated by the reference value calculating unit; and a throughput expected value/estimated value calculating unit (realized by, for example, the throughput expected value/estimated value calculating unit 213) which, when the sustainability comparing unit decides that the sustainability at which the throughput can be sustained without exceeding the expected throughput value is the predetermined threshold or more, calculates the expected throughput value after addition of a system resource amount as an estimated value of the expected throughput value which is optimal.

(9) A throughput sustaining support device (for example, the management server 200A having the throughput sustaining reference generating device 100A) has: a throughput sustaining decision unit (realized by, for example, the throughput sustaining decision unit 210) which decides whether or not throughput can be sustained without exceeding a throughput expected value in a server system based on correspondence data (for example, the simulation result) between a throughput value of the server system and a surplus amount of a system resource measured using the expected throughput value which is the throughput value expected upon the number of requests in advance for the server system (for example, the business system 300) and pattern data (for example, the simulation pattern data) which indicates a pattern of a processing request matching an operating situation of the server system; and a decision result output unit (realized by, for example, the throughput sustaining decision result output unit 220) which outputs a decision result as to whether or not the throughput can be sustained without exceeding the expected throughput value decided by the throughput sustaining decision unit.

(10) The throughput sustaining support device may employ a configuration which has: a simulation process generating unit (realized by, for example, the simulation process generating unit 111) which generates simulation process for executing simulation by repeating processing of transmitting a processing request matching the pattern indicated by the pattern data to the server system and receiving a processing result from the server system using the expected throughput value and the pattern data; a resource difference amount measuring unit (realized by, for example, the resource difference amount measuring unit 112) which measures the throughput value of the server system while executing simulation using the simulation process generated by the simulation process generating unit and changing a system resource amount of the server system, and measures a difference amount between a reference system resource amount which the server system requires to sustain the throughput such that the throughput does not exceed the expected throughput value upon the expected number of processing requests in the server system, and a current system resource amount; and a reference value calculating unit (realized by, for example, the throughput sustaining reference calculating unit 113) which computes a sustainability at which throughput measured by the resource difference amount measuring unit can be sustained without exceeding the expected throughput value, based on the difference amount in the system resource amount measured by the resource difference amount measuring unit, and calculates a reference value (for example, the throughput sustaining reference) for deciding whether or not the throughput can be sustained without exceeding the expected throughput value, based on the obtained sustainability at which the throughput can be sustained without exceeding the expected throughput value, and in which the throughput sustaining decision unit decides whether or not the throughput can be sustained without exceeding the expected throughput value in the server system, based on the reference value calculated by the reference value calculating unit.

(11) The throughput sustaining support device may employ a configuration where the reference value calculating unit computes throughput sustaining densities obtained by multiplying a throughput value measured by the resource difference amount measuring unit and a reciprocal of the sustainability at which the throughput can be sustained without exceeding the calculated throughput expected value, and calculates a throughput sustaining density of the computed throughput sustaining densities which has a maximum value as a reference value for deciding whether or not the throughput can be sustained without exceeding the expected throughput value.

(12) The throughput sustaining support device may employ a configuration where the throughput sustaining decision unit includes a resource amount estimated value calculating unit (realized by, for example, the resource amount estimated value calculating unit 212) which calculates a difference amount in a system resource amount when the throughput sustaining density calculated by the reference value calculating unit has a maximum value as an estimated value of an optimal system resource amount at which the throughput can be sustained without exceeding the expected throughput value.

(13) The throughput sustaining support device may employ a configuration where the throughput sustaining decision unit includes a sustainability comparing unit (realized by, for example, the throughput sustainability comparing unit 211) which compares a sustainability at which the throughput can be sustained without exceeding the expected throughput value when a system resource amount is added, and a predetermined threshold based on the reference value calculated by the reference value calculating unit, and the resource amount estimated value calculating unit calculates a system resource amount after the addition as an estimated value of an optimal system resource amount when the sustainability comparing unit decides that the sustainability at which the throughput can be sustained without exceeding the expected throughput value is the predetermined threshold or more.

(14) The throughput sustaining support device may employ a configuration where, when deciding that the sustainability at which the throughput can be sustained without exceeding the expected throughput value is not a predetermined value or more, the sustainability comparing unit repeatedly executes processing of comparing the sustainability at which the throughput can be sustained without exceeding the expected throughput value when a system resource amount is further added, and a predetermined threshold.

(15) The throughput sustaining support device may employ a configuration where the throughput sustaining decision unit includes a resource amount comparing unit (realized by, for example, the resource amount comparing unit 214) which compares a difference amount in a system resource amount when the throughput sustaining density calculated by the reference value calculating unit has a maximum value, and a system resource upon decision in the server system; and when the resource amount comparing unit decides that the system resource amount of the server system runs out, the decision result output unit outputs an addition alert that a system resource amount needs to be added, and when the resource amount comparing unit decides that the system resource amount of the server system is surplus, outputs a limitation alert that a system resource amount needs to be limited.

(16) The throughput sustaining support device may employ a configuration where the throughput sustaining decision unit includes: a sustainability comparing unit (realized by, for example, the throughput sustainability comparing unit 211) which compares a sustainability at which the throughput can be sustained without exceeding the expected throughput value when a system resource amount is added, and a predetermined threshold based on the reference value calculated by the reference value calculating unit; and a throughput expected value/estimated value calculating means (realized by, for example, the throughput expected value/estimated value calculating unit 213) which, when the sustainability comparing unit decides that the sustainability at which the throughput can be sustained without exceeding the expected throughput value is the predetermined threshold or more, calculates the expected throughput value after addition of a system resource amount as an estimated value of the expected throughput value which is optimal.

(17) The throughput sustaining support system may employ a configuration which has: a throughput sustaining decision unit which decides whether or not throughput can be sustained without exceeding a throughput expected value in a server system based on correspondence data between a throughput value of the server system and a surplus amount of a system resource measured using the expected throughput value which is the throughput value expected upon the number of requests in advance for the server system and pattern data which indicates a pattern of a processing request matching an operating situation of the server system; and a decision result output unit which outputs a decision result as to whether or not the throughput can be sustained without exceeding the expected throughput value decided by the throughput sustaining decision unit.

(18) The throughput sustaining support system may employ a configuration which has: a simulation process generating unit which generates simulation process for executing simulation by repeating processing of transmitting a processing request matching the pattern indicated by the pattern data to the server system and receiving a processing result from the server system using the expected throughput value and the pattern data; a resource difference amount measuring unit which measures the throughput value of the server system while executing simulation using the simulation process generated by the simulation process generating unit and changing a system resource amount of the server system, and measures a difference amount between a reference system resource amount which the server system requires to sustain the throughput such that the throughput does not exceed the expected throughput value upon the expected number of processing requests in the server system, and a current system resource amount; and a reference value calculating unit which computes a sustainability at which throughput measured by the resource difference amount measuring unit can be sustained without exceeding the expected throughput value, based on the difference amount in the system resource amount measured by the resource difference amount measuring unit, and calculates a reference value for deciding whether or not the throughput can be sustained without exceeding the expected throughput value, based on the obtained sustainability at which the throughput can be sustained without exceeding the expected throughput value, and in which the throughput sustaining decision unit decides whether or not the throughput can be sustained without exceeding the expected throughput value in the server system, based on the reference value calculated by the reference value calculating unit.

(19) The throughput sustaining support system may employ a configuration where the reference value calculating unit computes throughput sustaining densities obtained by multiplying a throughput value measured by the resource difference amount measuring unit and a reciprocal of the sustainability at which the throughput can be sustained without exceeding the calculated throughput expected value, and calculates a throughput sustaining density of the computed throughput sustaining densities which has a maximum value as a reference value for deciding whether or not the throughput can be sustained without exceeding the expected throughput value.

(20) The throughput sustaining support system may employ a configuration where the throughput sustaining decision unit includes a resource amount estimated value calculating unit which calculates a difference amount in a system resource amount when the throughput sustaining density calculated by the reference value calculating unit has a maximum value as an estimated value of an optimal system resource amount at which the throughput can be sustained without exceeding the expected throughput value.

(21) The throughput sustaining support system may employ a configuration where the throughput sustaining decision unit includes a sustainability comparing unit which compares a sustainability at which the throughput can be sustained without exceeding the expected throughput value when a system resource amount is added, and a predetermined threshold based on the reference value calculated by the reference value calculating unit, and the resource amount estimated value calculating unit calculates a system resource amount after the addition as an estimated value of an optimal system resource amount when the sustainability comparing unit decides that the sustainability at which the throughput can be sustained without exceeding the expected throughput value is the predetermined threshold or more.

(22) The throughput sustaining support system may employ a configuration where, when deciding that the sustainability at which the throughput can be sustained without exceeding the expected throughput value is not a predetermined value or more, the sustainability comparing unit repeatedly executes processing of comparing the sustainability at which the throughput can be sustained without exceeding the expected throughput value when a system resource amount is further added, and a predetermined threshold.

(23) The throughput sustaining support system may employ a configuration where the throughput sustaining decision unit includes a resource amount comparing unit which compares a difference amount in a system resource amount when the throughput sustaining density calculated by the reference value calculating unit has a maximum value, and a system resource upon decision in the server system, and when the resource amount comparing unit decides that the system resource amount of the server system runs out, the decision result output unit outputs an addition alert that a system resource amount needs to be added and, when the resource amount comparing unit decides that the system resource amount of the server system is surplus, outputs a limitation alert that a system resource amount needs to be limited.

(24) The throughput sustaining support system may employ a configuration where the throughput sustaining decision unit includes: a sustainability comparing unit which compares a sustainability at which the throughput can be sustained without exceeding the expected throughput value when a system resource amount is added, and a predetermined threshold based on the reference value calculated by the reference value calculating unit; and the throughput expected value/estimated value calculating unit that, when the sustainability comparing unit decides that the sustainability at which the throughput can be sustained without exceeding the expected throughput value is the predetermined threshold or more, calculates the expected throughput value after addition of a system resource amount as an estimated value of the expected throughput value which is optimal.

(25) The throughput sustaining support device may employ a configuration which has: a throughput sustaining decision unit which decides whether or not throughput can be sustained without exceeding a throughput expected value in a server system based on correspondence data between a throughput value of the server system and a surplus amount of a system resource measured using the expected throughput value which is the throughput value expected upon the number of requests in advance for the server system and pattern data which indicates a pattern of a processing request matching an operating situation of the server system; and a decision result output unit which outputs a decision result as to whether or not the throughput can be sustained without exceeding the expected throughput value decided by the throughput sustaining decision unit.

(26) The throughput sustaining support device may employ a configuration which has: a simulation process generating unit which generates simulation process for executing simulation by repeating processing of transmitting a processing request matching the pattern indicated by the pattern data to the server system and receiving a processing result from the server system using the expected throughput value and the pattern data; a resource difference amount measuring unit which measures the throughput value of the server system while executing simulation using the simulation process generated by the simulation process generating unit and changing a system resource amount of the server system, and measures a difference amount between a reference system resource amount which the server system requires to sustain the throughput such that the throughput does not exceed the expected throughput value upon the expected number of processing requests in the server system, and a current system resource amount; and a reference value calculating unit which computes a sustainability at which throughput measured by the resource difference amount measuring unit can be sustained without exceeding the expected throughput value, based on the difference amount in the system resource amount measured by the resource difference amount measuring unit, and calculates a reference value for deciding whether or not the throughput can be sustained without exceeding the expected throughput value, based on the obtained sustainability at which the throughput can be sustained without exceeding the expected throughput value, and in which the throughput sustaining decision unit decides whether or not the throughput can be sustained without exceeding the expected throughput value in the server system, based on the reference value calculated by the reference value calculating unit.

(27) The throughput sustaining support device may employ a configuration where the reference value calculating unit computes throughput sustaining densities obtained by multiplying a throughput value measured by the resource difference amount measuring unit and a reciprocal of the sustainability at which the throughput can be sustained without exceeding the calculated throughput expected value, and calculates a throughput sustaining density of the computed throughput sustaining densities which has a maximum value as a reference value for deciding whether or not the throughput can be sustained without exceeding the expected throughput value.

(28) The throughput sustaining support device may employ a configuration where the throughput sustaining decision unit includes a resource amount estimated value calculating unit which calculates a difference amount in a system resource amount when the throughput sustaining density calculated by the reference value calculating unit has a maximum value as an estimated value of an optimal system resource amount at which the throughput can be sustained without exceeding the expected throughput value.

(29) The throughput sustaining support device may employ a configuration where the throughput sustaining decision unit includes a sustainability comparing unit which compares a sustainability at which the throughput can be sustained without exceeding the expected throughput value when a system resource amount is added, and a predetermined threshold based on the reference value calculated by the reference value calculating unit, and the resource amount estimated value calculating unit calculates a system resource amount after the addition as an estimated value of an optimal system resource amount when the sustainability comparing unit decides that the sustainability at which the throughput can be sustained without exceeding the expected throughput value is the predetermined threshold or more.

(30) The throughput sustaining support device may employ a configuration where, when deciding that the sustainability at which the throughput can be sustained without exceeding the expected throughput value is not a predetermined value or more, the sustainability comparing unit repeatedly executes processing of comparing the sustainability at which the throughput can be sustained without exceeding the expected throughput value when a system resource amount is further added, and a predetermined threshold.

(31) The throughput sustaining support device may employ a configuration where the throughput sustaining decision unit includes a resource amount comparing unit which compares a difference amount in a system resource amount when the throughput sustaining density calculated by the reference value calculating unit has a maximum value, and a system resource upon decision in the server system, and when the resource amount comparing unit decides that the system resource amount of the server system runs out, the decision result output unit outputs an addition alert that a system resource amount needs to be added and, when the resource amount comparing unit decides that the system resource amount of the server system is surplus, outputs a limitation alert that a system resource amount needs to be limited.

(32) The throughput sustaining support device may employ a configuration where the throughput sustaining decision unit includes: a sustainability comparing unit which compares a sustainability at which the throughput can be sustained without exceeding the expected throughput value when a system resource amount is added, and a predetermined threshold based on the reference value calculated by the reference value calculating unit; and the throughput expected value/estimated value calculating unit that, when the sustainability comparing unit decides that the sustainability at which the throughput can be sustained without exceeding the expected throughput value is the predetermined threshold or more, calculates the expected throughput value after addition of a system resource amount as an estimated value of the expected throughput value which is optimal.

Although the present invention has been described with reference to the above embodiment, the present invention is by no unit limited to the above embodiment. The configuration and the details of the present invention can be variously changed within a scope of the present invention which one of ordinary skill in art can understand.

This application claims priority to Japanese Patent Application No. 2010-37850 filed on Feb. 23, 2010, the entire contents of which are incorporated by reference herein.

### INDUSTRIAL APPLICABILITY

The present invention is applicable for use in an operating management system or a management server which supports that expected throughput is sustained in an online system on Internet, an intra-company system and a data center.

### REFERENCE SIGNS LIST

100 Throughput sustaining reference generating device
101 Input unit
102 Clock generating unit
103 Storage device
104 Throughput sustainability calculating unit
105 Transmitting/receiving unit
111 Simulation process generating unit
112 Resource difference amount measuring unit
113 Throughput sustaining reference calculating unit
114 Throughput sustaining reference transmitting unit
200 Management server
201 Provisioning event generation unit
202 Resource pool search unit
203 Provisioning event processing unit
210 Throughput sustaining decision unit
211 Throughput sustainability comparing unit
212 Resource amount estimated value calculating unit
213 Throughput expected value/estimated value calculating unit
214 Resource amount comparing unit
220 Throughput sustaining decision result output unit
300 Business system
301 Web server
302 Web AP server
303 DB server
304 Storage
400 Resource pool
500 Network

1-18. (canceled)

19. A throughput sustaining support system comprising:
a throughput sustaining decision unit which decides whether or not throughput can be sustained without exceeding the expected throughput value in a server system, based on the expected throughput value which is the throughput value expected upon a number of requests in advance for the server system, and the correspondence data between a throughput value of the server system and a surplus amount of a system resource, which measured by a pattern data which indicates a pattern of a processing request matching an operating situation of the server system; and
a decision result output unit which outputs a decision result as to whether or not the throughput can be sustained without exceeding the expected throughput value which decided by the throughput sustaining decision unit.

20. The throughput sustaining support system according to claim 19 comprising:
a simulation process generating unit which generates simulation process for executing simulation by repeating the actions of transmitting a processing request to the server system based on the pattern indicated by the pattern data and receiving a processing result from the server system, using the expected throughput value and the pattern data;
a resource difference amount measuring unit which measures the throughput value of the server system while executing simulation using the simulation process generated by the simulation process generating unit and changing a system resource amount of the server system, and measures the difference amount between a current system resource amount and a reference system resource amount which the server system requires to sustain the throughput such that the throughput does not exceed the expected throughput value upon the expected number of requests in the server system; and
a reference value calculating unit which computes a sustainability at which throughput measured by the resource difference amount measuring unit can be sustained without exceeding the expected throughput value, based on the difference amount in the system resource amount measured by the resource difference amount measuring unit, and calculates a reference value for deciding whether or not the throughput can be sustained without exceeding the expected throughput value, based on the obtained sustainability at which the throughput can be sustained without exceeding the expected throughput value,
wherein the throughput sustaining decision unit decides whether or not the throughput can be sustained without exceeding the expected throughput value in the server system, based on the calculated reference value by the reference value calculating unit.

21. The throughput sustaining support system according to claim 19,
wherein the reference value calculating unit computes throughput sustaining densities obtained by multiplying a throughput value measured by the resource difference amount measuring unit and a reciprocal value of the sustainability at which the throughput can be sustained without exceeding the calculated expected throughput value, and calculates a maximum value of the throughput sustaining density of the computed throughput sustaining densities, as a reference value for deciding whether or not the throughput can be sustained without exceeding the expected throughput value.

22. The throughput sustaining support system according to claim 21,
wherein the throughput sustaining decision unit comprises a resource amount estimated value calculating unit which calculates a difference amount in a system resource amount when the calculated throughput sustaining density by the reference value calculating unit comprises a maximum value as an estimated value of an optimal system resource amount at which the throughput can be sustained without exceeding the expected throughput value.

23. The throughput sustaining support system according to claim 22,
wherein the throughput sustaining decision unit comprises a sustainability comparing unit which compares a sustainability at which the throughput can be sustained without exceeding the expected throughput value when a system resource amount is added, and a predetermined threshold based on the calculated reference value by the reference value calculating unit; and
the resource amount estimated value calculating unit calculates a system resource amount after the addition as an estimated value of an optimal system resource amount when the sustainability comparing unit decides that the sustainability at which the throughput can be sustained without exceeding the expected throughput value is the predetermined threshold or more.

24. The throughput sustaining support system according to claim 23,
wherein, when deciding that the sustainability at which the throughput can be sustained without exceeding the expected throughput value is not a predetermined value or more, the sustainability comparing unit repeatedly executes processing of comparing the sustainability at which the throughput can be sustained without exceeding the expected throughput value when a system resource amount is further added, and a predetermined threshold.

25. The throughput sustaining support system according to claim 21,
wherein the throughput sustaining decision unit comprises a resource amount comparing unit which compares a difference amount in a system resource amount when the calculated throughput sustaining density by the reference value calculating unit comprises a maximum value, and a system resource upon decision in the server system; and
the decision result output unit when the resource amount comparing unit decides that the system resource amount of the server system runs out, outputs an addition alert that a system resource amount needs to be added, and when the resource amount comparing unit decides that the system resource amount of the server system is surplus, outputs a limitation alert that a system resource amount needs to be limited.

26. The throughput sustaining support system according to claim 21,
wherein the throughput sustaining decision unit comprises:
a sustainability comparing unit which compares sustainability at which throughput can be sustained without exceeding the expected throughput value when a system resource amount is added, and a predetermined threshold based on the calculated reference value by the reference value calculating unit; and
the throughput expected value/estimated value calculating unit which, when the sustainability comparing unit decides that the sustainability at which the throughput can be sustained without exceeding the expected throughput value is the predetermined threshold or more, calculates the expected throughput value after addition of a system resource amount as an estimated value of the expected throughput value which is optimal.

27. A throughput sustaining support device comprising:
a throughput sustaining decision unit which decides whether or not throughput can be sustained without exceeding the expected throughput value in a server system, based on the expected throughput value which is the throughput value expected upon a number of requests in advance for the server system, and the correspondence data between a throughput value of the server system and a surplus amount of a system resource, which measured by a pattern data which indicates a pattern of a processing request matching an operating situation of the server system; and
a decision result output unit which outputs a decision result as to whether or not the throughput can be sustained without exceeding the expected throughput value decided by the throughput sustaining decision unit.

28. The throughput sustaining support device according to claim 27, comprising:
a simulation process generating unit which generates simulation process for executing simulation by repeating the actions of transmitting a processing request to the server system based on the pattern indicated by the pattern data and receiving a processing result from the server system, using the expected throughput value and the pattern data;
a resource difference amount measuring unit which measures the throughput value of the server system while executing simulation using the simulation process generated by the simulation process generating unit and changing a system resource amount of the server system, and measures a difference amount between a reference system resource amount which the server system requires to sustain the throughput such that the throughput does not exceed the expected throughput value upon the expected number of requests in the server system, and a current system resource amount; and
a reference value calculating unit which computes a sustainability at which throughput measured by the resource difference amount measuring unit can be sustained without exceeding the expected throughput value, based on the difference amount in the system resource amount measured by the resource difference amount measuring unit, and calculates a reference value for deciding whether or not the throughput can be sustained without exceeding the expected throughput value based on the computed sustainability at which the throughput can be sustained without exceeding the expected throughput value,
wherein the throughput sustaining decision unit decides whether or not the throughput can be sustained without exceeding the expected throughput value in the server system, based on the calculated reference value by the reference value calculating unit.

29. The throughput sustaining support device according to claim 27,
wherein the reference value calculating unit computes throughput sustaining densities obtained by multiplying a throughput value measured by the resource difference amount measuring unit and a reciprocal value of the sustainability at which the throughput can be sustained without exceeding the calculated expected throughput value, and calculates a maximum value of the throughput sustaining density of the computed throughput sustaining densities, as a reference value for deciding whether or not the throughput can be sustained without exceeding the expected throughput value.

30. The throughput sustaining support device according to claim 29,
wherein the throughput sustaining decision unit comprises a resource amount estimated value calculating unit which calculates a difference amount in a system resource amount when the calculate throughput sustaining density by the reference value calculating unit comprises a maximum value as an estimated value of an optimal system resource amount at which the throughput can be sustained without exceeding the expected throughput value.

31. The throughput sustaining support device according to claim 30,
wherein the throughput sustaining decision unit comprises a sustainability comparing unit which compares a sustainability at which the throughput can be sustained without exceeding the expected throughput value when a system resource amount is added, and a predetermined threshold based on the calculated reference value by the reference value calculating unit; and
the resource amount estimated value calculating unit calculates a system resource amount after the addition as an estimated value of an optimal system resource amount when the sustainability comparing unit decides that the sustainability at which the throughput can be sustained without exceeding the expected throughput value is the predetermined threshold or more.

32. The throughput sustaining support device according to claim 31,
wherein, when deciding that the sustainability at which the throughput can be sustained without exceeding the expected throughput value is not a predetermined value or more, the sustainability comparing unit repeatedly executes processing of comparing the sustainability at which the throughput can be sustained without exceeding the expected throughput value when a system resource amount is further added, and a predetermined threshold.

33. The throughput sustaining support device according to claim 29,
wherein the throughput sustaining decision unit comprises a resource amount comparing unit which compares a difference amount in a system resource amount when the calculated throughput sustaining density by the reference value calculating unit comprises a maximum value, and a system resource upon decision in the server system; and
the decision result output unit when the resource amount comparing unit decides that the system resource amount of the server system runs out, outputs an addition alert that a system resource amount needs to be added, and when the resource amount comparing unit decides that the system resource amount of the server system is surplus, outputs a limitation alert that a system resource amount needs to be limited.

34. The throughput sustaining support device according to claim 29,
wherein the throughput sustaining decision unit comprises:
a sustainability comparing unit which compares sustainability at which throughput can be sustained without exceeding the expected throughput value when a system resource amount is added, and a predetermined threshold based on the calculated reference value by the reference value calculating unit; and
the throughput expected value/estimated value calculating unit which, when the sustainability comparing unit decides that the sustainability at which the throughput can be sustained without exceeding the expected throughput value is the predetermined threshold or more, calculates the expected throughput value after addition of a system resource amount as an estimated value of the expected throughput value which is optimal.

35. A throughput sustaining support method comprising:
deciding whether or not throughput can be sustained without exceeding the expected throughput value in a server system, based on the expected throughput value which is the throughput value expected upon a number of requests in advance for the server system, and the correspondence data between a throughput value of the server system and a surplus amount of a system resource, which measured by a pattern data which indicates a pattern of a processing request matching an operating situation of the server system; and
outputting a decision result as to whether or not the throughput can be sustained without exceeding the expected throughput value.

36. A computer readable information recording medium storing a throughput sustaining support program, when executed by a processor, performs a method for:
deciding whether or not throughput can be sustained without exceeding the expected throughput value in a server system, based on the expected throughput value which is the throughput value expected upon a number of requests in advance for the server system, and the correspondence data between a throughput value of the server system and a surplus amount of a system resource, which measured by a pattern data which indicates a pattern of a processing request matching an operating situation of the server system; and
outputting a decision result as to whether or not the throughput can be sustained without exceeding the expected throughput value.
